(19) United States
(12) Patent Application Publication
(10) Pub. No.: US 2024/0333470 A1
(43) Pub. Date: Oct. 3, 2024

(54) SYSTEM AND METHOD FOR ENABLING SHORT DISTANCE SECURE COMMUNICATION

(71) Applicant: JIO PLATFORMS LIMITED, Ahmedabad (IN)

(72) Inventors: Debashis DUTTA, Navi Mumbai (IN); Chandan MAITY, Navi Mumbai (IN); Shivraj DAGADI, Bangalore (IN); Anish SHAH, Mumbai (IN)

(21) Appl. No.: 18/246,507

(22) PCT Filed: Jan. 25, 2023
(86) PCT No.: PCT/IB2023/050627

§ 371 Date: Mar. 23, 2023

(30) Foreign Application Priority Data
Jan. 26, 2022 (IN) 202221004337

(51) Int. Cl. H04L 9/00; H04L 9/30; H04L 9/32

(52) U.S. Cl. CPC H04L 9/006; H04L 9/3066; H04L 9/3239

(57) ABSTRACT

The present disclosure provides a robust solution to an entity or an organization by enabling the entity to implement a system that provides an alternate mechanism compared to the standard near field communication (NFC) based communication. The system enables a standard smartphone to communicate secure data while providing an enhanced range of communication through an audio mode of transmission between entities. Further, alternative mode of transmissions such as a Bluetooth mode of transmission, a quick response code (QR) based mode of transmission, and a wireless fidelity (Wi-Fi) based mode of transmission are used for enabling short distance secure communication between entities. Secure storage, secure computation, or processing is performed within a public key infrastructure (PKI) enabled subscriber identity module (SIM) card for providing an effective solution.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for facilitating short distance secure communication in telecommunications systems. More particularly, the present disclosure relates to a system and a method for short distance secure communication in a telecommunications network that is secure, provides multiple modes of communication, and is hardware agnostic.

### BACKGROUND OF THE INVENTION

The following description of related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Mobile-based short-distance digital payments are used for various types of online and offline transaction. Especially, near-field communication (NFC) based transactions are used for digital payments. In NFC-based transactions, a smartphone communicates with another smartphone or an electronic Point of Sale (POS) device at a very short distance in a peer-to-peer mode with a significantly high level of security. During digital payments, secure transactional information is transferred through the NFC. Multiple cards such as debit, credit, and the like, can be virtually emulated in an NFC-enabled smart phone without compromising security requirements. In any NFC-based communication, a secure element (SE) and an NFC communication module (with 13.56 megahertz) radio frequency (RF)) are primary requirements for digital transactions. Usually, the SE is an isolated hardware element based on a separate microprocessor or microcontroller that primarily consists the RF baseband processor and an encoder-decoder. Incorporation of the SE and the NFC communication module imposes significant costs and restricts users from purchasing an NFC-enabled smartphone.

Conventional solutions have limited hardware peripherals that are incapable of hardware enhancement. Additionally, the cost of mobile handset upgradation is high and adds to the limitation of present-day inventions. Further, conventional solutions lack a specific type of RF communication mode(s) essential for various types of input and output peripherals. Specifically, the NFC lacks an alternative type of communication mode that is beneficial in digital transactions.

There is, therefore, a need in the art to provide a system and a method that can mitigate the problems associated with the prior arts.

### OBJECTS OF THE INVENTION

Some of the objects of the present disclosure, which at least one embodiment herein satisfies are listed herein below.

It is an object of the present disclosure to provide a system and a method that facilitates secure storage within a subscriber identity module (SIM) card.

It is an object of the present disclosure to provide a system and a method that facilitates secure computation within the SIM card.

It is an object of the present disclosure to provide a system and a method that provides various modes of communication associated with user requirements.

It is an object of the present disclosure to provide a system and a method that enhances the range of communication with the enablement of various input and output peripherals.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for enabling short distance secure communication. The system may include one or more processors operatively coupled to a primary entity. The primary entity may be associated with a user and may be connected to the one or more processors. The primary entity may be operably coupled to a subscriber identity module (SIM) card. The one or more processors may be coupled with a memory that stores instructions to be executed by the one or more processors. The one or more processors may generate one or more data parameters based on one or more target applications requested by the user associated with the primary entity. Further, the one or more processors may encrypt the generated one or more data parameters based on the requested target applications using one or more primary techniques. The one or more processors may predict an audio mode of communication through an artificial intelligence (AI) engine based on the generated one or more encrypted data. Further, the one or more processors may enable the communication of the one or more encrypted data from the primary entity to a secondary entity via the audio mode of communication.

In an embodiment, the one or more processors may be configured to packetize the generated one or more data parameters based on the one or more target applications prior to generating the one or more encrypted data.

In an embodiment, the one or more target applications may include at least one or more payment information and sensitive information associated with the one or more target applications.

In an embodiment, the one or more processors may be configured to encrypt the generated one or more data parameters using a certified authority/public key infrastructure (CA/PKI) feature.

In an embodiment, the one or more processors may be configured to encrypt the one or more generated data parameters using one or more asymmetric keys and the one or more primary techniques.

In an embodiment, the one or more processors may be configured to encrypt the one or more generated data parameters using one or more symmetric keys and the one or more primary techniques.

In an embodiment, the one or more primary techniques may include any or a combination of a Rivest-Shamir-Adleman (RSA) technique and an elliptical curve cryptography (ECC) technique to encrypt the one or more generated data parameters with the one or more asymmetric keys.

In an embodiment, the one or more primary techniques may include any or a combination of an advanced encryption standard (AES) technique, a data encryption standard (DES) technique, and a triple data encryption standard (3 DES) technique to encrypt the one or more generated data parameters with the one or more symmetric keys.

In an embodiment, the one or more processors may be configured to use any or a combination of a secure hash algorithm (SHA) technique and a message-digest algorithm 5 (MD5) technique to encrypt the one or more generated data parameters.

In an embodiment, the audio mode of communication may utilize frequency shift keying (FSK) to enable the communication of the one or more encrypted data from the primary entity to the secondary entity.

In an embodiment, the audio mode of communication may include an audio amplitude variation to enable the communication of the one or more encrypted data from the primary entity to the secondary entity.

In an embodiment, the audio mode of communication may utilize one or more frequencies to enable the communication of the one or more encrypted data from the primary entity to the secondary entity.

In an aspect, the present disclosure relates to a method for enabling communication of data between a primary entity and a secondary entity. The method may include generating, by one or more processors, one or more data parameters based on one or more target applications requested by a user associated with the primary entity. The primary entity may be operably coupled to a subscriber identity module (SIM) card. Further, the method may include encrypting, by the one or more processors, the generated one or more data parameters based on the requested one or more target applications using one or more primary techniques. The method may include predicting, by the one or more processors, an audio mode of communication based on the one or more encrypted data through an artificial intelligence (AI) engine. Further, the method may include enabling, by the one or more processors, the communication of the one or more encrypted data from the primary entity to the secondary entity via the audio mode of communication.

In an embodiment, the method may include encrypting, by the one or more processors, the one or more generated data parameters using a certified authority/public key infrastructure (CA/PKI) feature.

In an embodiment, the method may include encrypting, by the one or more processors, the one or more generated data parameters using one or more asymmetric keys and the one or more primary techniques.

In an embodiment, the method may include encrypting, by the one or more processors, the one or more generated data parameters using one or more symmetric keys and the one or more primary techniques.

In an embodiment, the one or more primary techniques may include any or a combination of a Rivest-Shamir-Adleman (RSA) technique and an elliptical curve cryptography (ECC) technique to encrypt the one or more generated data parameters with the one or more asymmetric keys.

In an embodiment, the one or more primary techniques may include any or a combination of a an advanced encryption standard (AES) technique, a data encryption standard (DES) technique, and a triple data encryption standard (3DES) technique to encrypt the generated one or more data parameters with the one or more symmetric keys.

In an embodiment, the audio mode of communication may utilize frequency shift keying (FSK) to enable the communication of the one or more encrypted data from the primary entity the secondary entity.

In an embodiment, the audio mode of communication may include an audio amplitude variation to enable the communication of the one or more encrypted data from the primary entity to the secondary entity.

In an embodiment, the audio mode of communication may utilize one or more frequencies to enable the communication of the one or more encrypted data from the primary entity to the secondary entity.

In an aspect, the present disclosure relates to a user equipment (UE) for generating one or more secure messages. The UE may include one or more primary processors communicatively coupled to one or more processors in a system, the one or more primary processors coupled with a memory, where the memory stores instructions which when executed by the one or more primary processors causes the UE to generate and transmit one or more data parameters based on one or more target applications requested by a user associated with the UE. The one or more processors may be configured to encrypt the received one or more data parameters received from the UE using one or more primary techniques based on the one or more target applications, predict, using an artificial intelligence (AI) engine, an audio mode of communication based on the generated one or more encrypted data, and enable the communication of the one or more encrypted data from the UE to a secondary entity via the audio one mode of communication.

In an embodiment, the UE may be operably coupled to a subscriber identity module (SIM) card for the generation and the transmission of the one or more data parameters.

In an aspect, the present disclosure relates to a subscriber identity module (SIM) card for enabling communication of data to a secondary entity. The SIM card may include one or more processors communicatively coupled to one or more processors in a system. The one or more processors may be coupled with a memory that stores instructions to be executed by the SIM card. The one or more processors may generate one or more data parameters based on one or more target applications requested by a user. The one or more processors may encrypt, using one or more primary techniques, the generated one or more data parameters based on the requested one or more target applications. The one or more processors may predict, using an artificial intelligence (AI) engine, an audio mode of communication based on the generated one or more encrypted data. The one or more processors may enable the communication of the one or more encrypted data from the SIM card associated with a primary entity to the secondary entity via the audio mode of communication.

In an aspect, the present disclosure relates to a system that enables communication of data between a primary entity and a secondary entity. The system may include one or more processors operatively coupled to the primary entity. The primary entity may be operably coupled to a SIM card. The primary entity may be associated with one or more users and may be connected to the one or more processors. The one or more processors may be coupled with a memory that stores instructions to be executed by the one or more processors. The one or more processors may generate one or more data parameters based on one or more target applications requested by the one or more users. Further, the one or more processors may encrypt the generated one or more data parameters. One or more primary techniques may be used to generate one or more encrypted data based on the one or more target applications requested by the one or more users. The one or more processors may determine a mode of communication through an artificial intelligence (AI) engine based on the generated one or more encrypted data. The determined mode of communication may include at least a Bluetooth mode of communication. Further, the one or more processors may enable the communication of the one or more encrypted data from the primary entity to the secondary entity via the determined mode of communication.

In an embodiment, one or more advertising channels may be associated with the Bluetooth mode of communication for transmission of the one or more encrypted data from the primary entity to the secondary entity.

In an embodiment, the one or more processors may be configured to transmit a public address and a private address associated with the one or more advertising channels of the Bluetooth mode of communication to the secondary entity.

In an embodiment, the Bluetooth mode of communication may use a data link layer with a physical specification of 4.X (LE 1M PHY) and 5.X (LE 2M PHY).

In an embodiment, the data link layer may include at least a preamble, an access address, a protocol data unit (PDU), a cyclic redundancy check (CRC), and a constant tone (CTE).

In an embodiment, the one or more encrypted data may be transmitted using a configurable interval from 20 milliseconds to 10.24 seconds along with a delay of 0 seconds to 0.625 milliseconds.

In an embodiment, the primary entity and the secondary entity may include one or more Bluetooth low energy (BLE) scanners to transmit and receive the one or more encrypted data through the one or more advertising channels.

In an aspect, the present disclosure relates to a method for communication of data between a primary entity and a secondary entity. The method may include generating, by one or more processors, one or more data parameters based on one or more target applications requested by one or more users. The one or more users may be associated with the primary entity that may be operably coupled to a SIM card. Further, the method may include encrypting, by the one or more processors, the generated one or more data parameters. One or more primary techniques may be used to generate one or more encrypted data based on the one or more target applications. The method may include determining a mode of communication through an artificial intelligence (AI) engine based on the generated one or more encrypted data. The determined mode of communication may include at least a Bluetooth mode of communication. Further, the method may include enabling, by the one or more processors, the communication of the one or more encrypted data from the primary entity to the secondary entity via the determined mode of communication.

In an aspect, the present disclosure relates to a user equipment for communication of data to a secondary entity. The UE may include a SIM card and one or more primary processors communicatively coupled to one or more processors in a system, the one or more primary processors coupled with a memory, where the memory stores instructions which when executed by the one or more primary processors causes the UE to generate and transmit one or more data parameters based on one or more target applications requested by one or more users associated with the UE. The one or more processors may be configured to receive the one or more data parameters from the UE, encrypt, using one or more primary techniques, the generated one or more data parameters based on the requested one or more target applications. The one or more processors may determine a mode of communication through an artificial intelligence (AI) engine based on the generated one or more encrypted data. The determined mode of communication may include at least a Bluetooth mode of communication. The one or more processors may enable the communication of the one or more encrypted data to the secondary entity via the determined mode of communication.

In an aspect, the present disclosure relates to a SIM card for enabling communication of data to a secondary entity. The SIM card may include one or more processors communicatively coupled to one or more processors in a system. The one or more processors may be coupled with a memory, where the memory stores instructions that when executed by the one or more processors causes the SIM card to generate one or more data parameters based on one or more target applications requested by a user, encrypt, using one or more primary techniques, the generated one or more data parameters based on the requested one or more target applications, predict, using an artificial intelligence (AI) engine, a Bluetooth mode of communication based on the generated one or more encrypted data, and enable the communication of the one or more encrypted data from the SIM card associated with a primary entity to the secondary entity via the Bluetooth mode of communication.

In an aspect, the present disclosure relates to a system that may include one or more processors operatively coupled to a primary entity. The primary entity may be associated with one or more users and may be connected to the one or more processors. The primary entity may be coupled to a subscriber identity module (SIM) card. The one or more processors may be coupled with a memory that stores instructions to be executed by the one or more processors. The one or more processors may generate one or more data parameters based on one or more target applications requested by the one or more users. Further, the one or more processors may encrypt the generated one or more data parameters. One or more primary techniques may be used to generate the one or more encrypted data based on the one or more target applications. The one or more processors may determine a mode of communication via an artificial intelligence (AI) engine based on the generated one or more encrypted data. The determined mode of communication may include at least a quick response code (QR) based mode of communication. The one or more processors may enable communication of the one or more encrypted data from the primary entity to a secondary entity via the determined mode of communication.

In an embodiment, the QR based mode of communication may include a binary mode of encoding to enable the communication of the one or more encrypted data from the primary entity to the secondary entity.

In an embodiment, the QR based mode of communication may include at least one of an error correction code (ECC), an error correction level, and an overhead associated with the encrypted one or more data.

In an embodiment, the QR based mode of communication may include a dynamic QR code associated with the encrypted one or more data to prevent one or more replay attacks during the communication of the one or more encrypted data from the primary entity to the secondary entity.

In an embodiment, the dynamic QR code may be updated within a predefined time interval to prevent the one or more replay attacks during the communication of the one or more encrypted data from the primary entity to the secondary.

In an aspect, the present disclosure relates to a method for enabling communication of data between a primary entity and a secondary entity. The method may include generating, by one or more processors, one or more data parameters based on one or more target applications requested by one or more users associated with the primary entity. The primary entity may be coupled to a subscriber identity module (SIM) card. Further, the method may include encrypting, by the one or more processors, the generated one or more data parameters. One or more primary techniques may be used to generate one or more encrypted data based on the one or more target applications. The method may include determining, by the one or more processors, a mode of communication via an artificial intelligence (AI) engine based on the one or more encrypted data. The determined mode of communication may include at least a quick response code (QR) based mode of communication. Further, the method may include enabling, by the one or more processors, the communication of the one or more encrypted data from the primary entity to the secondary entity via the determined mode of communication.

In an embodiment, the QR based mode of communication may use a binary mode of encoding to enable the communication of the one or more encrypted data from the primary entity to the secondary entity.

In an embodiment, the QR based mode of communication may include at least one of an error correction code (ECC), an error correction level, and an overhead associated with the encrypted one or more data.

In an embodiment, the QR based mode of communication may use a dynamic QR code associated with the encrypted one or more data to prevent one or more replay attacks during the communication of the one or more encrypted data from the primary entity to the secondary entity.

In an embodiment, the method may include updating, by the one or more processors, the dynamic QR code within a predefined time interval to prevent the one or more replay attacks during the communication of the one or more encrypted data from the primary entity to the secondary entity.

In an aspect, the present disclosure relates to a user equipment (UE) for generating one or more secure messages. The UE may include one or more primary processors communicatively coupled to one or more processors in a system, the one or more primary processors coupled with a memory, where the memory stores instructions which when executed by the one or more primary processors causes the UE to generate and transmit one or more data parameters based on one or more target applications requested by one or more users associated with the UE. The one or more processors may be configured to receive the one or more generated data parameters from the UE, encrypt, using one or more primary techniques, the generated one or more data parameters based on the requested one or more target applications, determine a mode of communication via an artificial intelligence (AI) engine based on the generated one or more encrypted data. The determined mode of communication may include at least a quick response code (QR) based mode of communication. The one or more processors may enable communication of the one or more encrypted data from the UE to a secondary entity via the determined mode of communication.

In an embodiment, the UE may be operatively coupled to a subscriber identity module (SIM) card.

In an aspect, a subscriber identity module (SIM) card for enabling communication of data to a secondary entity may include one or more processors operatively coupled to one or more processors in a system. The one or more processors may be coupled with a memory that stores instructions which when executed by the one or more processors may cause the one or more processors to generate one or more data parameters based on one or more target applications requested by one or more users. The one or more processors may encrypt, using one or more primary techniques, the generated one or more data parameters based on the requested one or more target applications. The one or more processors may determine a mode of communication via an artificial intelligence (AI) engine based on the generated one or more encrypted data. The determined mode of communication may include at least a quick response (QR) based mode of communication. The one or more processors may enable the communication of the one or more encrypted data from the SIM card associated with a primary entity to the secondary entity via the determined mode of communication.

In an aspect, the present disclosure relates to a system that may include one or more processors operatively coupled to a primary entity. The primary entity may be associated with one or more users, and may be connected to the one or more processors. The primary entity may be coupled to a subscriber identity module (SIM) card. The one or more processors may be coupled with a memory that stores instructions to be executed by the one or more processors. The one or more processors may generate one or more data parameters based on one or more target applications requested by the one or more users. Further, the one or more processors may encrypt the generated one or more data parameters. One or more combinations of primary techniques may be used to generate one or more encrypted data based on the one or more target applications. The one or more processors may determine a mode of communication via an artificial intelligence (AI) engine based on the generated one or more encrypted data. The determined mode of communication may include at least a wireless fidelity (Wi-Fi) based mode of communication. The one or more processors may enable the communication of the one or more encrypted data from the primary entity to a secondary entity via the determined mode of communication.

In an embodiment, one or more service set identifiers (SSIDs) may be associated with the Wi-Fi based mode of communication for communication of the one or more encrypted data from the primary entity to the secondary entity.

In an embodiment, the one or more processors may be configured to update the one or more SSIDs within a predefined interval. The predefined interval may be associated with the secondary entity.

In an embodiment, the one or more encrypted data may include at least a sequence number, a device identification (ID), a user data length, user data, and a cyclic redundancy check (CRC).

In an aspect, the present disclosure relates to a method for enabling communication of data between a primary entity and a secondary entity. The method may include generating, by one or more processors, one or more data parameters based on one or more target applications requested by one or more users. The one or more users may be associated with the primary entity. The primary entity may be coupled to a subscriber identity module (SIM) card. Further, the method may include encrypting, by the one or more processors, the generated one or more data parameters using one or more combinations of primary techniques based on the one or more target applications. The method may include determining, by the one or more processors, via an artificial intelligence (AI) engine a mode of communication using the one or more encrypted data, where the mode of communication may include at least a wireless fidelity (Wi-Fi) based mode of communication. Further, the method may include enabling, by the one or more processors, the communication of the one or more encrypted data from the primary entity to the secondary entity via the determined mode of communication.

In an aspect, the present disclosure relates to a user equipment (UE) for communication of data to a secondary entity. The UE may include a SIM card and one or more primary processors communicatively coupled to one or more processors in a system, the one or more primary processors coupled with a memory, where the memory stores instructions which when executed by the one or more primary processors causes the UE to generate and transmit one or more data parameters based on one or more target applications requested by one or more users associated with the UE. The one or more processors may be configured to receive the one or more generated data parameters from the UE, encrypt, using one or more primary techniques, the generated one or more data parameters based on the one or more target applications, determine a mode of communication via an artificial intelligence (AI) engine based on the generated one or more encrypted data, where the determined mode of communication may include at least a wireless fidelity (Wi-Fi) based mode of communication, and enable the communication of the one or more encrypted data to the secondary entity via the determined mode of communication.

In an aspect, a subscriber identity module card (SIM) card for enabling communication of data to a secondary entity may include one or more processors operatively coupled to one or more processors in a system. The one or more processors may include a memory that stores instructions to be executed by the one or more processors that may cause the one or more processors to generate one or more data parameters based on one or more target applications requested by one or more users. The one or more processors may encrypt using one or more primary techniques, the generated one or more data parameters based on the requested one or more target applications. The one or more processors may determine a mode of communication via an artificial intelligence (AI) engine based on the generated one or more encrypted data. The mode of communication may include at least a wireless fidelity (Wi-Fi) based mode of communication. The one or more processors may enable the communication of the one or more encrypted data from the SIM card associated with a primary entity to the secondary entity via the determined mode of communication.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1A illustrates an exemplary network architecture (100) of a proposed system (110), in accordance with an embodiment of the present disclosure.

FIG. 1B illustrates an exemplary system architecture (150) of a proposed system (110), in accordance with an embodiment of the present disclosure.

FIG. 2 illustrates an exemplary representation (200) of a proposed system (110), in accordance with an embodiment of the present disclosure.

FIG. 3 illustrates an exemplary representation of logical blocks (300) of a proposed system (110), in accordance with an embodiment of the present disclosure.

FIG. 4 illustrates an exemplary representation (400) of an application processor of a proposed system (110), in accordance with an embodiment of the present disclosure.

FIG. 5 illustrates an exemplary representation (500) of secure environment architecture, in accordance with an embodiment of the present disclosure.

FIG. 6 illustrates an exemplary representation of a smartphone external hardware peripheral (600), in accordance with an embodiment of the present disclosure.

FIG. 7 illustrates an exemplary representation of an internal architecture of a subscriber identity module (SIM) card operation (700), in accordance with an embodiment of the present disclosure.

FIG. 8 illustrates an exemplary representation of a secure communication over audio mode of communication (800), in accordance with an embodiment of the present disclosure.

FIG. 9 illustrates an exemplary representation of an audio-based secure communication (900), in accordance with an embodiment of the present disclosure.

FIG. 10 illustrates an exemplary representation of a detailed process flow (1000) including digital signature and encryption, in accordance with an embodiment of the present disclosure.

FIGS. 11A-11F illustrate exemplary representations (1100) of secure communication over Bluetooth, in accordance with an embodiment of the present disclosure.

FIG. 12 illustrates an exemplary representation (1200) of secure communication over quick response (QR), in accordance with an embodiment of the present disclosure.

FIG. 13 illustrates an exemplary representation (1300) of secure communication over wireless fidelity (Wi-Fi), in accordance with an embodiment of the present disclosure.

FIG. 14 illustrates an exemplary computer system (1400) in which or with which a proposed system (110) may be implemented, in accordance with an embodiment of the present disclosure.

The foregoing shall be more apparent from the following more detailed description of the disclosure.

### BRIEF DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

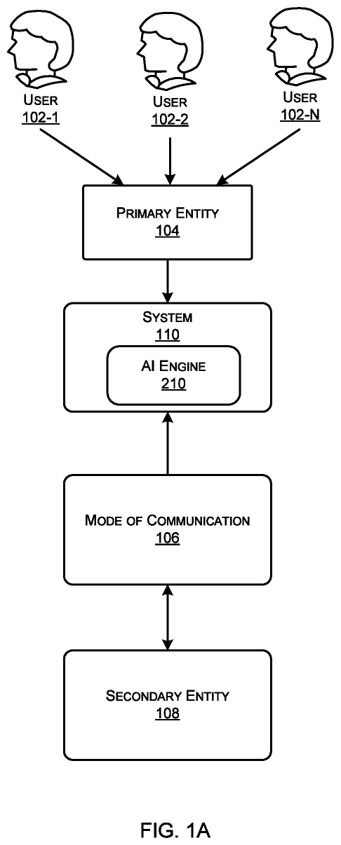

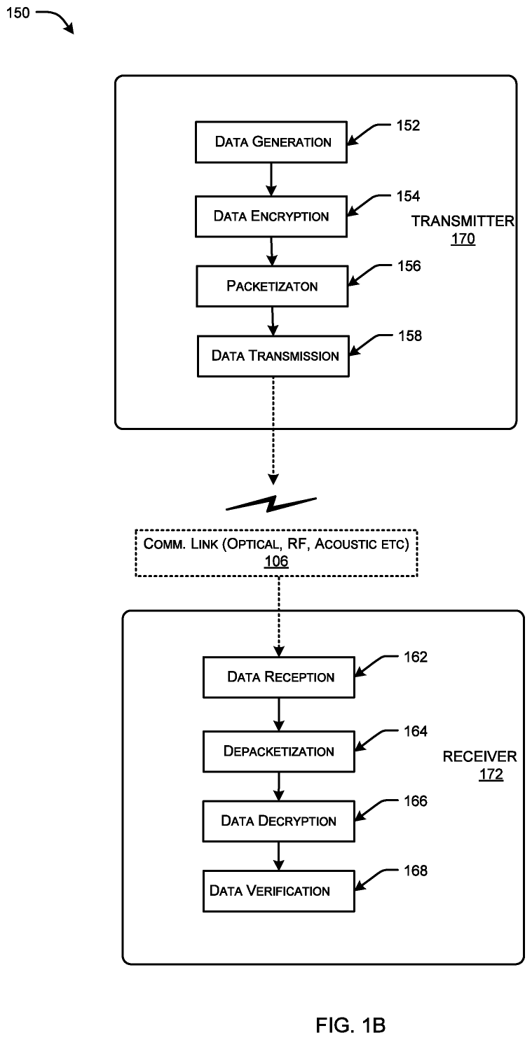

The various embodiments throughout the disclosure will be explained in more detail with reference to FIGS. 1-14.

FIG. 1A illustrates an exemplary network architecture (100) of a proposed system (110), in accordance with an embodiment of the present disclosure. As illustrated in FIG. 1A, a primary entity (104) may be communicate with a secondary entity (108) through a mode of communication (106). Although one primary entity (104) and one secondary entity (108) is depicted in FIG. 1A, however, any number of primary and/or secondary entities may be present in the network architecture (100).

Referring to FIG. 1A, the system (110) may enable the communication of data between the primary entity (104) and the secondary entity (108). In an embodiment, the primary entity (104) and/or secondary entity (108 may also be known as user equipment (UE) that may include, but not be limited to, a mobile, a laptop, etc. Further, the primary entity (104) and/or the secondary entity (108) may include one or more in-built or externally coupled accessories including, but not limited to, a visual aid device such as a camera, audio aid, a microphone, or a keyboard. Furthermore, the primary entity (104) and/or the secondary entity (108) may include a smartphone, virtual reality (VR) devices, augmented reality (AR) devices, a general-purpose computer, desktop, personal digital assistant, tablet computer, and a mainframe computer. Additionally, input devices for receiving input from a user (102-1, 102-2 . . . 102-N) such as a touch pad, touch-enabled screen, electronic pen, and the like may be used.

Referring to FIG. 1A, the primary entity (104) and the secondary entity (108) may be communicatively connected with each other through a mode of communication (106). In an embodiment, the system (110) may generate one or more data parameters based on one or more target applications requested by one or more users (102-1, 102-2 . . . 102-N). A person of ordinary skill in the art will understand that the one or more users (102-1, 102-2 . . . 102-N) may be collectively referred as the users (102) and individually referred as the user (102). In an embodiment, the one or more target applications may include, but not be limited to, payment information or any other sensitive data. Further, the system (110) may include an artificial intelligence (AI) engine (210) for predicting the mode of communication (106) based on the one or more target applications requested by the users (102). In an embodiment, the mode of communication (106) may include, but not be limited to, audio, Bluetooth, quick response (QR) code, and wireless fidelity (Wi-Fi). In an embodiment, the system (110) may transmit one or more encrypted data to the secondary entity (108).

Although FIG. 1A shows exemplary components of the network architecture (100), in other embodiments, the network architecture (100) may include fewer components, different components, differently arranged components, or additional functional components than depicted in FIG. 1A. Additionally, or alternatively, one or more components of the network architecture (100) may perform functions described as being performed by one or more other components of the network architecture (100).

FIG. 1B illustrates an exemplary system architecture (150) of a proposed system (110), in accordance with an embodiment of the present disclosure.

As illustrated in FIG. 1B, the system architecture (150) includes a transmitter (170) and a receiver (172). A person of ordinary skill in the art will appreciate that the transmitter (170) may be similar to the primary entity (104) of FIG. 1A in its functionality. Further, a person of ordinary skill in the art will appreciate that the receiver (172) may be similar to the secondary entity (108) of FIG. 1A in its functionality.

Referring to FIG. 1B, the transmitter (170) may include a data generation block (152) for generation of one or more data parameters. Data generation may be supervised (manually entered or attended) or un-supervised (i.e., automatically fetched or unattended). The generated data or data parameters may be encrypted at a data encryption block (154). Once the encryption of the data parameters is completed, the encrypted data parameters may go through a packetization block (156) based on a type of peripheral. Packetization may include generation of one or more data packets based on the encrypted data parameters. Further, the packetized data may be configured based on the one or more modes of communication predicted by an AI engine such as the AI engine (210) of FIG. 1. Data transmission block (158) may include activation of the desired output peripheral and hardware protocol level configuration for transmission of the packetized data to the receiver (172) using a data communication link (106).

In an embodiment, the data communication link (106) may include basic attributes such as, but not limited to, time (bit rate), image quality (in case of a quick response (QR) image), distance of communication based on the optical, radio frequency (RF), and acoustic mode of transmission. In an embodiment, the receiver (172) may be similar to the transmitter (170), but in a reverse mode. The receiver (172) may be configured to scan the data transmitted by the transmitter (170) and select an application specific peripheral (input). Data reception block (162) may control the protocol level configuration to perform the task of receiving the data. Once the data is captured in receiver frontend peripheral, depacketization of the data is performed at a depacketization block (164). Based on the type of communication mode (optical, RF, acoustic, etc.) and size of the data packet(s), the depacketization block (164) may parse the desired data leaving the protocol layer overheads.

Further, the depacketized data may be decrypted at a data decryption block (166). After decryption, the data is verified at a data verification block (168) and further processed based on one or more target applications requested by users such as the users (102) of FIG. 1A.

In an exemplary embodiment, a subscriber identity module (SIM) card enabled with public key infrastructure (PKI) may be included at the transmitter (170) (for example, the primary entity (104) of FIG. 1A) and the receiver (172) (for example, the secondary entity (108) of FIG. 1A). Additionally, the PKI-enabled SIM card may have the following features.
A suitable certifying authority (CA) infrastructure support.
Onboard key pair generation and protection of private key inside SIM.
Secure storage of Rivest-Shamir-Adleman (RSA) or elliptical curve cryptography (ECC) keys and digital certificates.
Secure storage of user data.
Signing of any user data.
Encryption and decryption of any data with: asymmetric keys and algorithms such as (RSA, ECC), and/or with symmetric keys and algorithms such as, but not limited to, an advanced encryption standard (AES), a data encryption standard (DES), and a triple data encryption standard (3DES).
Support of hashing algorithm such as, but not limited to, a secure hash algorithm (SHA) and a message-digest algorithm (MD5).
Access protection of SIM card applet through appropriate keys and algorithm (secure communication protocol (SCP)—02, 03, 10, 11).

In an exemplary embodiment, Wi-Fi, Bluetooth, quick response code (QR), audio, and the like may be used in any combination to provide communication of data between the transmitter (170) and the receiver (172). The data communication link (106) may be configured for one or more modes of communication in a specific way to provide a faster transaction cycle time and a maximum data rate. The communication range may also be configurable for the respective mode of communication. In an embodiment, audio may be used as a medium to share transactional data. In an exemplary embodiment, Frequency Shift Keying (FSK) may be used in audio-based data transmission. Audio amplitude may be controlled to configure the communication range. In an exemplary embodiment, the mode of communication may include video, haptic, and touch based technology.

It may be appreciated that the system architecture (150) may be modular and flexible to accommodate any kind of changes in the system (150).

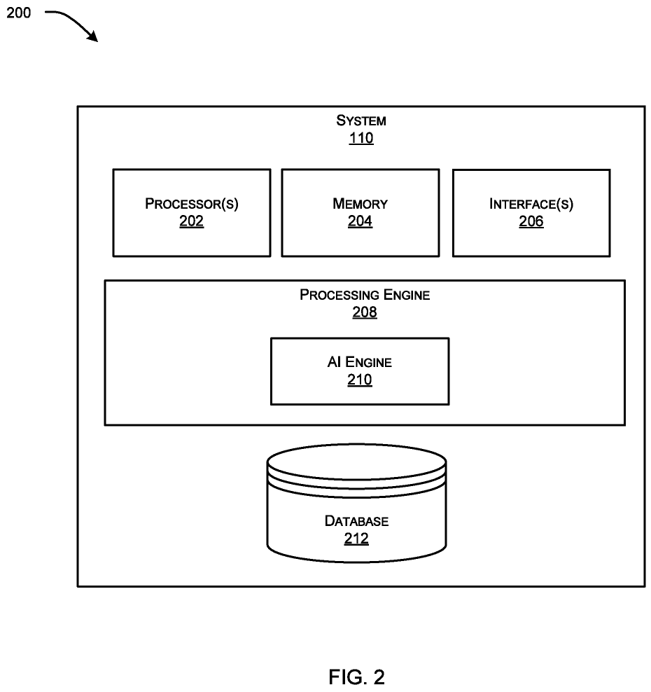

FIG. 2 illustrates an exemplary representation (200) of a proposed system (110), in accordance with an embodiment of the present disclosure. A person of ordinary skill in the art will understand that the system (110) of FIG. 2 may be similar to the system (110) of FIG. 1 in its functionality.

Referring to FIG. 2, the system (110) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (110). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (110) may include an interface(s) (206). The interface(s) (206) may comprise a variety of interfaces, for example, interfaces for data input and output (I/O) devices, storage devices, and the like. The interface(s) (206) may facilitate communication through the system (110). The interface(s) (206) may also provide a communication pathway for one or more components of the system (110). Examples of such components include, but are not limited to, processing engine(s) (208) and a database (212).

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (110) may comprise the machine-readable storage medium storing the instructions and the processing resource to execute the instructions, or the machine-readable storage medium may be separate but accessible to the system (110) and the processing resource. In other examples, the processing engine(s) (208) may be implemented by electronic circuitry.

In an embodiment, the one or more processor(s) (202) may be configured to generate one or more data parameters based on one or more target applications requested by one or more users (102) of FIG. 1A. The one or more processors (s) (202) may store the generated one or more data parameters in the database (212). The processing engine(s) (208) may include an AI engine (210) for predicting a mode of communication for data between a primary entity (104) and a secondary entity (108).

In an embodiment, the one or more processors (202) may be configured to packetize the generated one or more data parameters based on the one or more target applications. Further, the one or more processors (202) may be configured to encrypt the one or more generated data parameters using a certified authority/public key infrastructure (CA/PKI) feature.

In an embodiment, the one or more processors (202) may be configured to encrypt the one or more generated data parameters using one or more asymmetric keys and one or more combination of primary techniques. Alternatively, or additionally, the one or more processors (202) may be configured to encrypt the one or more generated data parameters using one or more symmetric keys and one or more combination of primary techniques.

In an embodiment, the one or more primary techniques used by the one or more processors (202) may comprise any or a combination of an RSA technique and/or an ECC technique to encrypt the one or more generated data parameters with the one or more asymmetric keys.

In an embodiment, the one or more primary techniques used by the one or more processors (202) may comprise any or a combination of an AES technique, a DES technique, and a 3DES technique to encrypt the one or more generated data parameters with the one or more symmetric keys.

In an embodiment, the one or more processors (202) may be configured to use any or a combination of an SHA technique and an MD5 technique to encrypt the one or more generated data parameters.

In an embodiment, the predicted mode of communication may include at least an audio mode of communication, a Bluetooth mode of communication, a QR based mode of communication, and a Wi-Fi based mode of communication for enabling a short distance communication between the primary entity (104) and the secondary entity (108).

In an embodiment, the audio mode of communication configured by the one or more processors (202) utilizes frequency shift keying (FSK) to enable the communication of the one or more encrypted data from the primary entity (104) to the secondary entity (108). In an embodiment, the audio mode of communication includes an audio amplitude variation to enable the communication of the one or more encrypted data from the primary entity (104) to the secondary entity (108). In an embodiment, the audio mode of communication utilizes one or more frequencies to enable the communication of the one or more encrypted data from the primary entity (104) to the secondary entity (108).

In an embodiment, the one or more processors (202) may be configured to transmit a public address and a private address associated with one or more advertising channels of the Bluetooth based mode of communication to the secondary entity (108). In an embodiment, the primary entity (104) and the secondary entity (108) may comprise one or more Bluetooth low energy (BLE) scanners to transmit and receive the one or more encrypted data through the one or more advertising channels. In an embodiment, wherein the Bluetooth mode of communication uses a data link layer with a physical specification of 4.X (LE 1M PHY) and 5.X (LE 2M PHY). In an embodiment, the data link layer comprises at least a preamble, an access address, a protocol data unit (PDU), a cyclic redundancy check (CRC), and a constant tone (CTE). In an embodiment, the one or more encrypted data is transmitted using a configurable interval ranging from 20 milliseconds to 10.24 seconds with a delay of 0 seconds to 0.625 milliseconds.

In an embodiment, the QR based mode of communication uses a binary mode of encoding to enable the communication of the one or more encrypted data from the primary entity (104) to the secondary entity (108). In an embodiment, the QR based mode of communication comprises at least one of an error correction code (ECC), an error correction level, and an overhead associated with the encrypted one or more data. In an embodiment, the QR based mode of communication uses a dynamic QR code associated with the encrypted one or more data to prevent one or more replay attacks during the communication of the one or more encrypted data from the primary entity (104) to the secondary entity (108). In an embodiment, the dynamic QR code is updated within a predefined time interval to prevent the one or more replay attacks during the communication of the one or more encrypted data from the primary entity (104) to the secondary entity (108).

In an embodiment, one or more service set identifiers (SSIDs) are associated with the Wi-Fi based mode of communication to enable the communication of the one or more encrypted data from the primary entity (104) to the secondary entity (108). In an embodiment, the one or more processors (202) are configured to update the one or more SSIDs within a predefined interval, and wherein the predefined interval is associated with the secondary entity (108). In an embodiment, the one or more encrypted data comprise at least a sequence number, a device identification (ID), a user data length, user data, and a cyclic redundancy check (CRC).

It may be appreciated that the system architecture (200) may be modular and flexible to accommodate any kind of changes in the system (200).

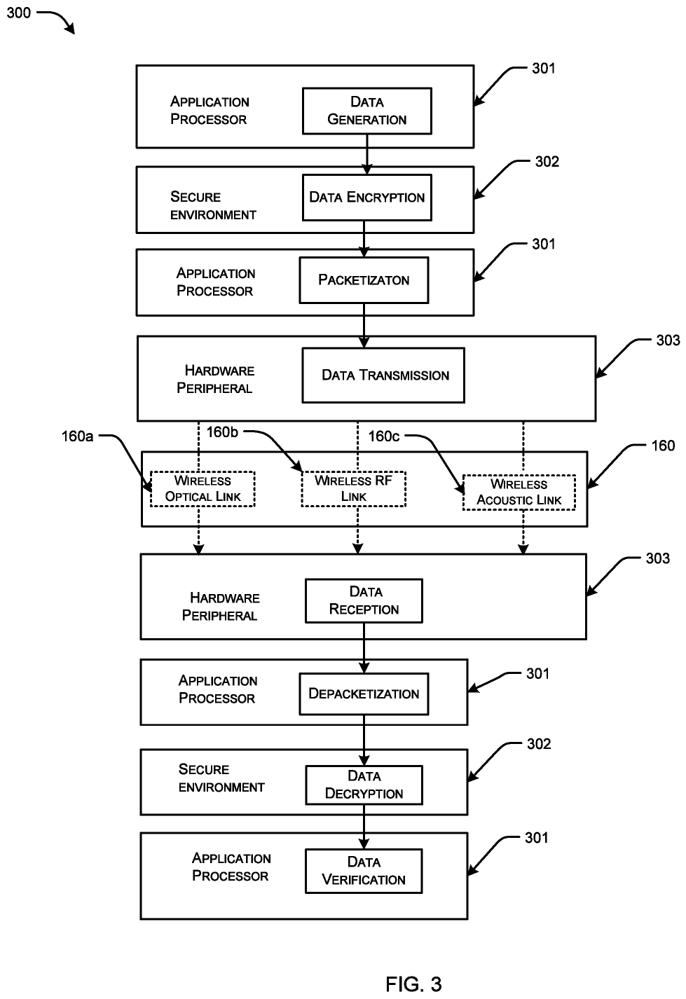

FIG. 3 illustrates an exemplary representation of logical blocks (300) of the proposed system (110), in accordance with an embodiment of the present disclosure.

As shown in FIG. 3, the logical blocks in FIG. 1B of the proposed system (110) are mapped into/onto a physical hardware present in computing devices such as, but not limited to, smartphones. As illustrated in FIG. 3, the corresponding physical sections may be classified into three segments including an application processor (301), a secure environment (302), a hardware peripheral (303), and a data communication link (160). In an embodiment, the data communication link (160) may include a wireless optical link (160a), a wireless radio frequency link (160b), and a wireless acoustic link (160c) for enabling communication of data between a transmitter and a receiver (for example, the transmitter (170) and the receiver (172) of FIG. 1B).

In an exemplary embodiment, various modes of communication may be enabled over a secure computation platform i.e. PKI-SIM. Further, the SIM card may be embedded as an e-SIM or a normal SIM card. The communication subsystems with heterogeneous hardware modules may be available in any smartphone or device. Further, single or multiple modes of hardware modules may be used by the application processor (301) to fulfil requirements of secure data communication over a short distance.

The application processor (301) may either use a single hardware peripheral (for example only Bluetooth or QR code) or it may use multiple hardware peripherals (such as Bluetooth with QR and Wi-Fi) based on the application requirements.

For example, a non-PKI-SIM device may create a digitally signed document with the support of a PKI-SIM enabled smart phone. Pre-requisites may include communication of a non-PKI-SIM enabled phone with a PKI enabled phone. Here, the non-PKI-SIM enabled phone (behaves as a slave) may collect (over a QR mode of communication) the following information from PKI-SIM enabled phone (treated as master):
a) The root certificate of CA
b) The certificate of PKI-SIM enabled phone
   The following steps in detail describe short distance secure communication using a QR mode of communication:
1. The non-PKI enabled SIM selects a file, extracts its digest (SHA256) and generates a QR code which contains master device (PKI-SIM enabled) with a message digest.
2. The PKI-SIM enabled device captures the QR from slave, signs the information inside the SIM card and regenerates the QR of signed information.
3. The slave (NON-PKI-SIM enabled phone) scans the QR from the master and finally prepares the signed document by appending the signature with original document that may be shared with people or devices.

Similarly, the system may be utilized for two PKI-SIM enabled devices where signed and/or encrypted message transfer may be possible with asymmetric cryptography or PKI framework.

It may be appreciated that the logical blocks (300) may be modular and flexible to accommodate any kind of changes.

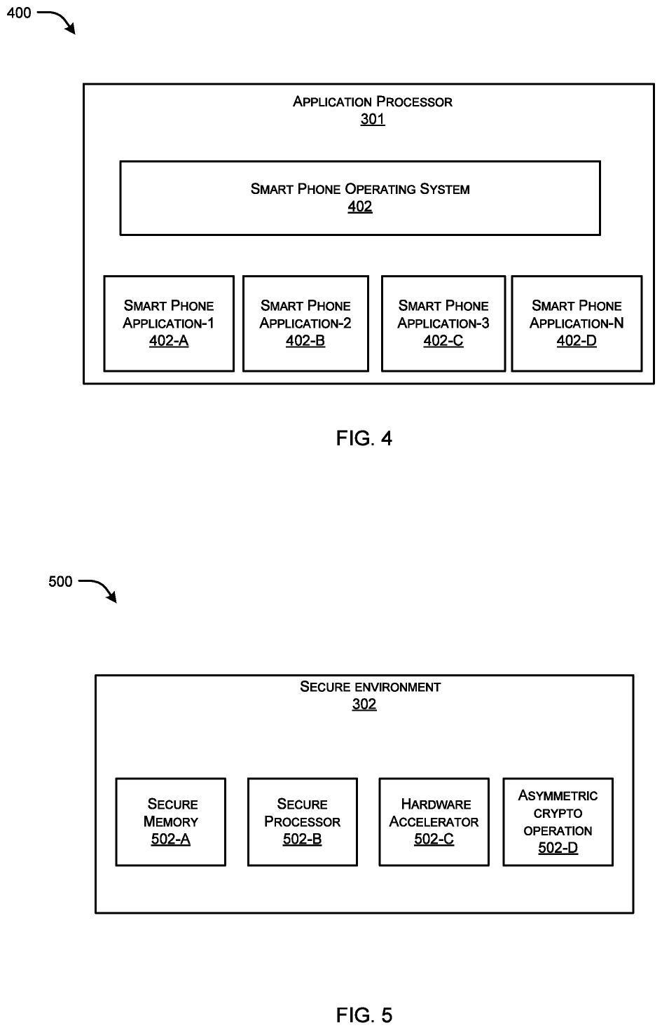

FIG. 4 illustrates an exemplary representation (400) of an application processor (301) of the proposed system (110), in accordance with an embodiment of the present disclosure. A person of ordinary skill in the art will appreciate that the application processor (301) of FIG. 4 may be similar to the application processor (301) of FIG. 3 in its functionality. The application processor (301) may include data generation, data encryption, and packetization as shown in FIG. 3.

In an embodiment, the application processor (301) may contain a multi-core central processing unit (CPU) and a general purpose input/output (GPIO) feature. The application processor (301) may primarily run a smart phone operating system (OS) (402) and user-level applications. It may be appreciated that the user-level applications (402-A, 402-B, 402-C, 402-D) may be independent of each other and follow their respective life-cycle.

In an exemplary embodiment, the user-level applications (402-A, 402-B, 402-C, 402-D) may include, but not be limited to, a payment application or any other secure/sensitive applications. Alternatively or additionally, sensitive operations may be performed by a secure processor independent of the application processor (301).

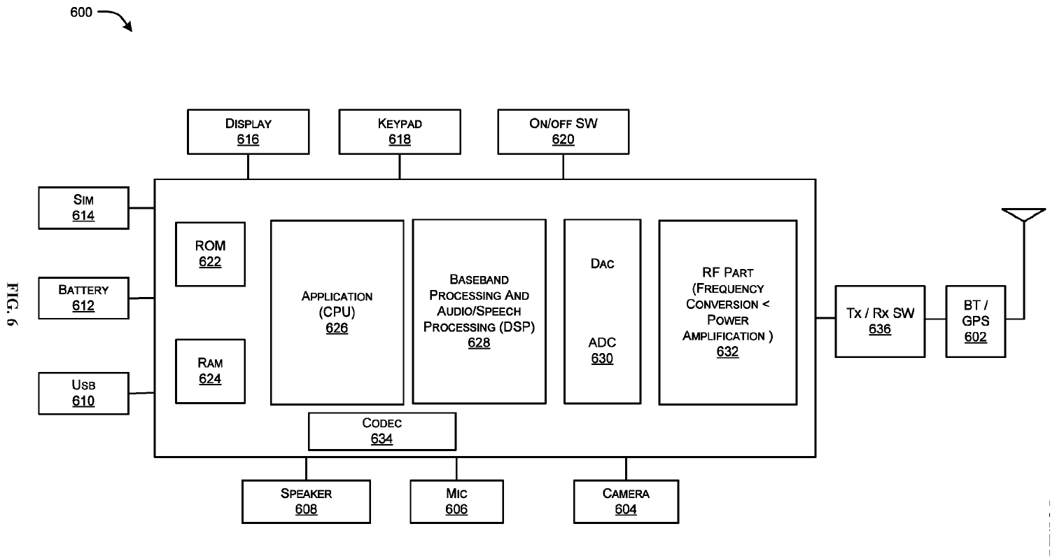

FIG. 5 illustrates an exemplary representation (500) of secure environment architecture (302), in accordance with an embodiment of the present disclosure. A person of ordinary skill in the art will appreciate that the secure environment (302) of FIG. 5 may be similar to the secure environment (302) of FIG. 3 in its functionality.

In an embodiment, the secure environment (302) may contain a single processor or controller or a chip set based on various independent designs of an original equipment manufacturer (OEM). As illustrated, the secure environment (302) may contain a secure memory (502-A) to ensure that the data may be extracted or fetched by a specific handshaking method. The secure environment (302) may be a separate hardware unit or maybe an integrated part of a secure processor (502-B). The secure processor (502-B) may compute various logical operations without exposing any data. Further, a hardware accelerator (502-C) may be incorporated with the secure processor (502-B) to enable high-speed computations. Furthermore, an asymmetric cryptographic operation (502-D) may provide complex cryptographic operations in the secure environment (302). In many configurations, the hardware accelerator (502-C) and the asymmetric cryptographic operation(502-D) may be linked to the secure processor (502-B).

FIG. 6 illustrates an exemplary representation of a smartphone external hardware peripheral (600), in accordance with an embodiment of the present disclosure.

As illustrated in FIG. 6, the smartphone with SIM (614) may include hardware with external hardware peripherals, such as a display (616) to send an image. Further, the smartphone may include a microphone (MIC) (606) to capture audio or acoustic data, a speaker (608) to transmit audio or acoustic data, and a universal serial bus (USB) (610) to communicate with other devices. Out of the many input and output peripherals, the externally available peripherals such as an on/off switch (620), a keypad (618), and the display (616) may be considered as communication channels for securing the transactions. Further, the smartphone may be enabled with a global positioning system (GPS) (602) to enable location tracking and/or Bluetooth (602) to enable transmission of data. Furthermore, the smartphone may be provided with a battery (612) to supply power to the external hardware peripherals.

Additionally, the smartphone may contain other hardware components such as a read only memory (ROM) (622), a random access memory (RAM) (624), and application/central processing unit (CPU) (626). The smartphone may further contain a baseband processing and an audio speech processing digital signal processor (DSP) (628), digital to analog convertor/analog to digital convertor (DAC/ADC) (630), a radio frequency (RF) part (632), a coder-decoder (CODEC) (634), and a transmission/reception switch (Tx/Rx SW) (636).

It may be appreciated that the smartphone (600) may be modular and flexible to accommodate any kind of changes.

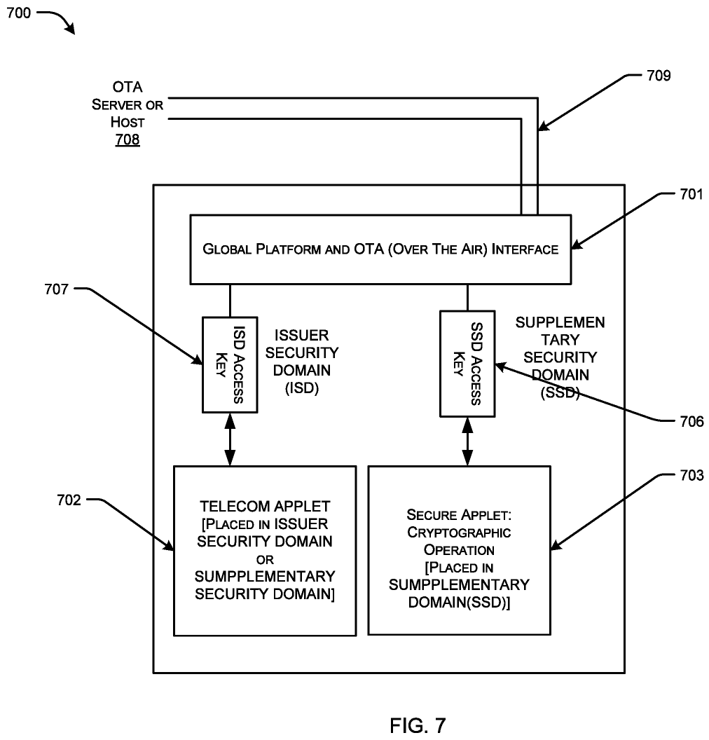

FIG. 7 illustrates an exemplary representation of an internal architecture of a SIM card (700), in accordance with an embodiment of the present disclosure.

As illustrated in FIG. 7, SIM card (700) may contain a global platform and over the air (OTA) interface (701) and a telecom applet (702). The telecom applet (702) may be accessed using an issuer security domain (ISD) access key-1 (707). A new application such as a secure applet (703) may be added to enable the SIM card (700) with all the functionalities of a secure environment as indicated in block (302) of FIG. 3 or FIG. 5. The secure applet (703) may be placed in a supplementary security domain (SSD)(706) to prevent other applets or applications from accessing the secure applet (703). Additionally, the SIM card (700) may be safely accessed using a global platform and host (708) or a hypertext transfer protocol secure (HTTPS) route (709). Further, the SIM card (700) may be protected from side channel access after deployment.

In an embodiment, a SIM card applet (703) may contain all the features of the PKI environment with the following attributes of the secure applet (703):
Onboard key pair generation and protection of private key inside SIM.
Secure storage of RSA or ECC keys and digital certificates.
Secure storage of user data.
Signing of any user data.
Encryption of any data with asymmetric keys and algorithms (RSA. ECC) and/or symmetric keys (AES, DES, 3DES).
Decryption of any data.
Support hashing algorithm such as an SHA and an MD5.
Access protection of SIM card applet via appropriate keys and algorithm (SCP-02, 03, 10, 11).

In an exemplary implementation, the encryption and decryption techniques may include a symmetric key and/or an asymmetric key. In the case of symmetric key-based security, the SIM card (700) shown in FIG. 7 may be equipped with secure storage of the generated key pairs. For an asymmetric key-based security, the SIM card (700) may be equipped with a PKI-based framework. The PKI framework may contain its process flow of key generation, CA, digital certificate generation (at CA), digital certificate storage (at SIM card), etc.

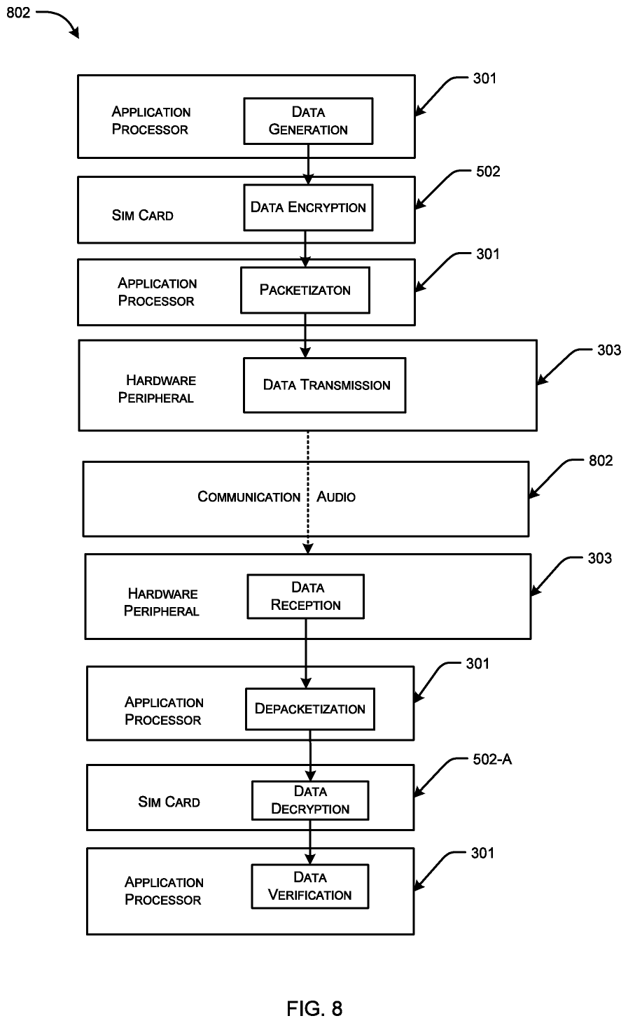

FIG. 8 illustrates an exemplary representation of secure communication over audio (802), in accordance with an embodiment of the present disclosure.

In an exemplary embodiment, an audio interface may be a mode of communication for contactless short distance communication between a transmitter and a receiver. As illustrated, the audio or acoustic communication block (802) may create a one-way audio transmission link. The performance of audio and supported frequency spectrum may depend on the manufacturer of the hardware peripheral (303). In an embodiment, the selected frequency may be in a human audible frequency range i.e. 20 hertz to 20 kilohertz. In another embodiment, the suggested frequency band may be between 1 kilohertz to 12 kilohertz for achieving wide support across all devices. There may be various options for audio modulation, however, frequency shift keying (FSK) modulation may be primarily used as it does not vary with amplitude or distance between the transmitter and the receiver. SIM card (502) may be the transmitter and the SIM card (502-A) may be the receiver. It may be appreciated that other blocks such as the data generation, data encryption, packetization, and data transmission are similar to the respective blocks illustrated in FIG. 1B. Similarly, data reception, depacketization, data decryption, and data verification are similar to the blocks illustrated in FIG. 1B. Additionally, the application processor (301) and hardware peripheral (303) are similar to the blocks illustrated in FIG. 1B.

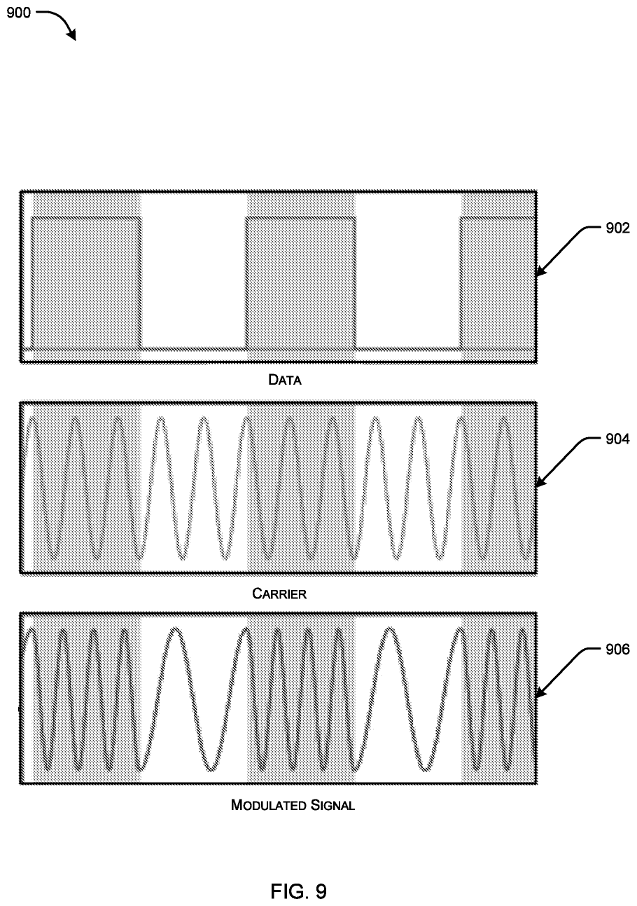

FIG. 9 illustrates an exemplary representation of an audio-based secure communication (900), in accordance with an embodiment of the present disclosure.

A typical FSK modulation technique has been represented in FIG. 9. The desired data (902) has to be modulated (906) with a selected carrier frequency (904) supported by smartphone hardware, which may be in the range of 20 hertz to 20 kilohertz. The data transmission rate may be configured as per specific application usage as a higher data transmission rate requires short distance. In an embodiment, a data transmission rate from 100 bits per second to 3 kilobits per second may be considered.

To avoid audio interference, the audio stream (or data stream) may be protected with unique static or dynamic “signature tune” which may be a special sequence of audio frequency spectrum or a modulated audio as a header of a data frame. Also, the entire data may have suitable features like cyclic redundancy check (CRC) or HASH to ensure data integrity at a physical layer.

Apart from the mentioned wireless communication methods, there may be many other wireless or wired communication modes which may have a similar architecture where a secure environment is provided by the SIM card. In the embodiments mentioned, the communication types and the communication distance between the transmitter and the receiver may be configured or controlled by following parameters as indicated in Table 1.

TABLE 1

| | Range control |
|---|---|
| Communication Mode | Parameters |
| Audio/Acoustic | Audio amplitude |
| | Microphone gain |

The above-mentioned communication method along with a secure environment may be used in various permutations and combinations based on the application usage, reliability, fast operation, user easiness, security needs, etc.

As an example, the process described below is a typical payment transaction and interaction of devices where one device may be a standard smartphone and another device may be an embedded PoS device or SIM card with cryptographic features. The present disclosure explains mechanisms for short distance communication between two devices where primarily one device is a smartphone and other devices may be another smartphone or any other electronic equipment including a PoS) terminal.

In a practical scenario, two devices come under operation for a transaction where one device may be called a sender and another called a recipient. Based on the use case, the device(s) may work with automated or with manual support further known as “operation mode” or “OM.” All the proposed OMs may be classified where at least two parties (sender and receiver) may be having attributes based on the application requirements. A detailed logical flow of the sender and receiver device's operations is described in the sections below. The OMs may be independent of the mode of physical layer communication i.e. Wi-Fi, QR, Bluetooth, or audio as a medium.
The sender is attended and the receiver is attended
The sender is attended and the receiver is non-attended
The sender is non-attended and the receiver is attended
The sender is non-attended and the receiver is-non attended

Physical Link: The communication links proposed in the OMs are based on primarily two types of media: Bluetooth low energy (BLE) and QR code image.

Mode of Direction: The entire communications mode may work in “simplex mode” which may include one-way data transfer. Additionally, there will be “no pairing” required for achieving an automated data transfer at a faster speed. The word automated indicates that no manual intervention is needed to establish the link such as receiver ID (ID or identity signifies the target's name) with suitable passcode or password. All the proposed OMs are mentioned with a unidirectional data flow without pairing. Further, bidirectional communication may be established by creating two concurrent unidirectional channels initiated from either side of the transmitter and the receiver respectively.

Distance: To achieve low-range (distance) data transfer just like the near field communication (NFC), the communication modes in OMs must be chosen with the lowest transmitting power. Although it is not mandatory, it may help to avoid interfaces and enable faster transactions. The word transaction indicates the completion of all the cycles of unidirectional data transfer. However, a limit of transmitting several packets may not be required, but in the lowest power configuration mode, the BLE data may be restricted to detect shorter distances.

Type of transmission: All the OMs may be implemented without any pairing or handshaking, hence the transmission type must include “broadcast.” Further, the recipient in the vicinity may be able to accept or listen to the data. Hence, the transmitted data maybe encrypted suitably to ensure decryption by a target recipient.

Type of reception: There is no external trigger or handshaking mechanism involved. The recipient or receiver shall continuously receive the data available in the vicinity. Only data that is specifically targeted for recipients (with an appropriate name, encoding, or encryption technique) shall be filtered and processed further for consumption. Suitable acknowledgment also shall be generated. The acknowledgment data may be sent back to the transmitter with a suitable mechanism (same or different channel of communication) based on appropriate OM.

Data type: The type of transmission may include “broadcast.” All the devices with reception capability in the vicinity will be able to see or read the data. Hence, the data may be encrypted suitably if protection is required. All the data may be captured by any other listener within the limited range, hence the data can be decrypted using a unique digital signature.

Data Size: The data transmission is of broadcast type may limit the data size. In various OMs or mediums, the sizes of data may be different. For example, the below table 2 indicates the data size for audio media.

TABLE 2

| | | Broadcast | |
|---|---|---|---|
| Media | Parameter Name | Data Size | Remark |
| Audio | Audio stream | 100-500 bps | The higher data rate, short |
| | | | distance, and high |
| | | | interference |

Based on the required data to be transmitted, a series of data streams or multiple packets may be transmitted in sequence. The sequence number during transmission or reception may be driven by the application layer.

Transaction: A transaction may include multiple unidirectional data transmissions from either side (sender and recipient) to complete a cycle initiated by either party with acknowledgment.

Operation Mode (OM) Details: Any of the mentioned OMs indicated may be applicable for any transaction cycle. The selection of specific OM may be based on the application type which may include manual intervention or automatic operation of devices. As shown in Table 3, various modes of communication between a seller and a buyer may be performed based on the specific use case.

TABLE 3

| S. | | |
|---|---|---|
| No | Seller (attended) -QR(T, R) | Buyer (Attended)-QR(T, R) |
| 1 | Transaction Initiated. | Idle -> Waiting & Manual |
| | The seller asks the payment by | Scan |
| | generating a QR code with | |
| | “Payment claim data 1” | |
| 2 | Waiting and Manual Scan | Buyer shall scan the “claim |
| | | data,” it will be processed on |
| | | smartphone and generate the |
| | | “payment transfer data 2” |
| | | over QR |
| 3 | Seller shall scan the “payment | Waiting and Manual Scan |
| | transfer data,” verifies and then | |
| | generates “Payment Receipt data 3” | |
| 4 | Waiting and Manual mode-> idle | Buyer shall scan the “Payment |
| | | Receipt data,” and shall store |
| | | or consume as payment |
| | | acknowledgment. Transaction |
| | | completed, system idle |

Data field Details: In the communication types, various data fields are mentioned below.

Seller-Info and Buyer-Info: Contains unique tamperproof identity of Seller and Buyer respectively.

Payment Claim Data: Contains sensitive and encrypted data of payment amount and product info (optional) along with Seller Identity (Mandatory) and Buyer Identity (optional).
Payment Transfer Data
Payment Receipt Data
Payment Info
Transaction Completed Message

TABLE 4

| Sl | Data | | Optional/ | |
|---|---|---|---|---|
| No | Element | Data parts | Mandatory | Remark |
| 1 | Seller-Info | Contains unique | Mandatory | It should be a |
| | | tamperproof | | tamperproof ID |
| | | identity of Seller | | such as digital |
| | | | | certificate |
| 2 | Buyer-Info | Contains unique | Mandatory | It should be a |
| | | tamperproof | | tamperproof ID |
| | | identity of Buyer | | such as digital |
| | | | | certificate |
| 3 | Payment | Payment Amount | Mandatory | Data in suitable |
| | Claim Data | | | currency. Data |
| | | | | should be encrypted |
| | | Product Info | Optional | Metadata of Product |
| | | | | info |
| | | Seller Info | Mandatory | It should be a |
| | | | | tamperproof ID |
| | | | | such as Digital |
| | | | | Certificate |
| | | Buyer Info | Optional | It should be a |
| | | | | tamperproof ID |
| | | | | such as Digital |
| | | | | Certificate |
| 4 | Payment | Payment Amount | Mandatory | Data in suitable |
| | Transfer | | | currency. Data |
| | Data | | | should be encrypted |
| | | Payment | Mandatory | The Token can be |
| | | Transaction | | Digitally signed |
| | | ID/Token ID | | data or Transaction |
| | | | | ID. This data should |
| | | | | be Encrypted |
| | | Seller Info | Mandatory | It should be a |
| | | | | tamperproof ID |
| | | | | such as digital |
| | | | | certificate |
| | | Buyer Info | Optional | It should be a |
| | | | | tamperproof ID |
| | | | | such as digital |
| | | | | certificate |
| 5 | Payment | Transaction ID | Mandatory | The Token can be |
| | Receipt Data | | | Digitally signed |
| | | | | data or Transaction |
| | | | | ID. This data should |
| | | | | be Encrypted |
| | | Seller Signature | Mandatory | The Seller |
| | | | | Signature indicates |
| | | | | the Unique code of |
| | | | | the seller as proof of |
| | | | | Acknowledgement. |
| | | | | It can be digitally |
| | | | | signed information |
| | | | | or other suitable |
| | | | | data to prove non- |
| | | | | repudiation of seller |
| | | | | acknowledgment |
| 6 | Payment | Payment Amount | Mandatory | Data in suitable |
| | Info | | | currency. Data |
| | | | | should be encrypted |
| | | Product Info | Optional | Meta data of |
| | | | | Product info |
| 7 | Transaction | Transaction/Token | Mandatory | Masked Transaction |
| | Completed | ID | | or Token |
| | Message | | | identification (ID) |
| | | | | can be used in plain |
| | | | | text |
| | | End-of-Message | Mandatory | Any suitable bit- |
| | | | | stream can be used |

Data security is a very serious concern when sensitive or payment data are concerned in an open network. Encryption with PKI is the most suitable way to avoid any third-party attacks.

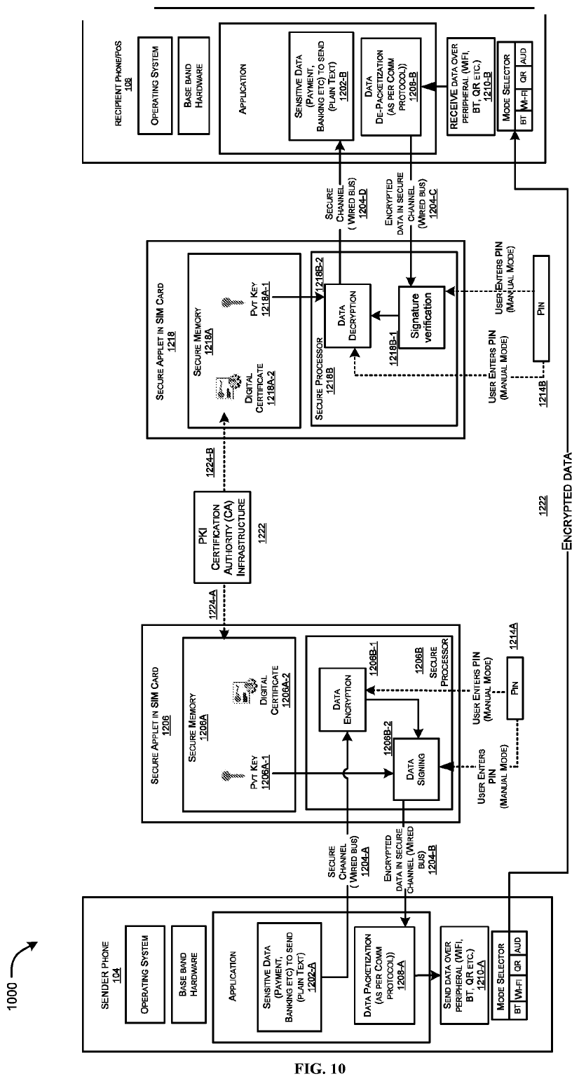

FIG. 10 illustrates an exemplary representation of a detailed process flow including digital signature and encryption (1000), in accordance with an embodiment of the present disclosure.

As illustrated, the SIM card may perform all the operations of a secure module. The SIM card consists of a secure memory and a secure processor. With a suitable partition, the applications inside the SIM card may also be placed to work independently without interfering with each other. In an exemplary implementation, two smartphones block (104) and block (108) may be participating devices intended for secure transactions. Both devices may communicate with PKI-enabled SIM cards indicated as block (1206) and block (1218) respectively. Further, the devices may contain identical functional logical sub-blocks with different working principles based on the use-case. All PKI-enabled SIM cards may interact with the remote certification authority (CA) as indicated in block (1222).

In an exemplary implementation, both devices (104) and (108) (Sender and Receiver) may contain components for transmission and reception.

The sender side (104)process flow may include the following:

The transaction may be initiated from a sender device indicated at block (104). Any authorized application prepares the data (in block (1202A)) to be sent securely to another device (block (108)). The plain text data in block (1202A) that needs to be protected may be sent to the PKI-enabled SIM card (1206) through an existing wired bus. The secure channels (1204A) and (1204B) may be optionally protected by a suitable SCP standard derived from Global Specification such as SCP-01/02/03 etc. The security standards may also provide “authorization” capabilities to the specific or selected application/s residing in a user's smartphone.

The SIM card (1206) of a sender (104) device may have a secure memory (1206A) and a secure processor (1206B). The secure memory (1206A) may contain pertinent sensitive data such as a sender's private key (1206A-1) and a digital certificate (1206A-2). The private key may be generated at the very beginning of PKI initialization or the “key pair generation” process. The digital certificate may be obtained by interaction with remote CA as indicated in block (1222) during PKI initialization too.

The plain text data (1202A) is taken in a secure process block (1206B-1) in the SIM card's secure processor (1206B). The encryption process is authorized by providing the user's personal identification number (PIN)(1214A) and encrypted by the recipient's public key.

The recipient's public key is extracted from the recipient's digital certificate (RDC). The RDC is made available to the sender's device by two possible mechanisms: a) directly from the recipient's device (desired and preferable) in case of pure offline (no internet or back-end connectivity) and b) from CA server (1222) requesting with recipient's identity such as a mobile number. In this case, when the other party's digital certificate is obtained through an offline mechanism (audio), the data route shall be a secure channel (such as (1204A), (1204B)) with host mobile, the data packetization block (1208-A) and the peripheral block (1210-A).

The encryption type performed in block (1206B-1) is asymmetric RSA or ECC or a hybrid i.e. combination of symmetric algorithms such as AES, a DES, and a 3DES, etc. and asymmetric algorithms (RSA, ECC, etc.). The output produced at block (1206B-1) is secure data and transferred to data signing block (1206B-2).

The encrypted data is digitally signed by the sender's private key (1206A-1) in the data signing block (1206B-2). The signing process ensures the origin of the transaction. It also requires the user's authorization by providing a PIN block (1214A).

Once the data is encrypted (1206B-1) and signed (1206B-2) in the SIM card's secure processor (1206), it goes back to the sender's phone (104) for further step of data packetization block (1208A).

In the data packetization block (1208A), the encrypted data is prepared as per the modality of communication, which may be an audio based, Bluetooth based, QR based, and/or Wi-Fi based transmission.

In this context, it is necessary to mention that the same data packetization block (1208A) is also used for any auxiliary communication between the sender and the receiver to obtain the recipient's RDC. For simplicity, it has not been indicated in the diagram.

Once the packetization is completed in block (1208A), the data is transferred to block (1210A) to select the suitable mode of communication.

Block (1210A) is a generic representation of communication modalities which can be one or multiple wireless/optical peripheral types such as Wi-Fi, Bluetooth, QR, audio, etc. For example, the certificate information also known as auxiliary data can use only QR as communication media. Sensitive data (1204-B) can use QR and Bluetooth in conjunction with communication. The selection and combination of communication modalities are user and use-case specific. A few specific use cases scenario may be referred to correlate the multiple communication modalities. Finally, the secured data is transferred via link block (1222) from the sender device block (104) to the recipient's device block (108).

In an exemplary embodiment, the recipient's side process flow may be given as follows:

The encrypted and signed data (1204-B) is transferred via link block (1222) from the sender's device block (104) to the specific block (1210B) of the recipient block (108).

In a similar fashion to the sender's block (1210A), (1210B) is also a generic representation of communication modalities at the recipient's end and can be one or multiple wireless/optical peripheral types to receive data from single or multiple peripherals.

The data received at block (1210B) may be fragmented or may be available in parts as per communication property. The packets are sent to the depacketization block (1208B) where the depacketization block (1208B) reverses the operation as per the sender's packetization block (1204A).

Once the depacketization is done, the entire data is available at the recipient's side in an encrypted form. Data is sent to a PKI-enabled SIM (1218) of the recipient's side via a wired link block (1204C) between the device (108) and the SIM card's(1218) secure processing unit (1218B).

The communication channels(1204-C) and (1204-D) on the recipient's side may be optionally protected by suitable SCP given by a global specification such as SCP-Jan. 2, 2003 etc. The security standards may also give “authorization” capabilities to the specific or selected application(s) residing in a host smartphone by sharing suitable symmetric keys for communication layer security.

In an exemplary implementation, the recipient (108) may also contain the PKI-enabled SIM card (1218) with secure memory (1218A) and a secure processor (1218B). The secure memory (1218A) may mandatorily contain sensitive data such as a recipient's private key (1218A-1) and a digital certificate (1218A-2). The private key may be generated at the very beginning of PKI initialization or the “key pair generation” process. The digital certificate (1218A-2) may be obtained by interaction with a remote CA as indicated in block (1222) during the PKI initialization process.

Additionally, the recipient's SIM card (1218) and the received encrypted data are sent to block (1218B-1) for verification of the sender's digital certificate to ensure authentication and record of the transaction.

In an exemplary implementation, the sender's public key is extracted from the sender's digital certificate (SDC). The SDC is made available to the recipient's device by the mechanisms:
a) Directly from the recipient's device in case of pure offline (no internet or back-end connectivity) and
b) From the CA Server (1222) requesting the recipient's identity.

In the case where the digital certificate is obtained through an offline mechanism, the data route shall be a secure channel (such as (1204-C), (1204-D)) with the host mobile, the data de-packetization block (1208-B), and the peripheral block (1210-B).

Further, once the digital signature is verified, the encrypted data is sent to the decryption block (1218B-2). The data originally encrypted with the recipient's key at the sender's SIM may be decrypted using the recipient's private key. The user authorization, the private key of the recipient (1218A-1), and the user authorization PIN(1214B) are required to perform the decryption process which may be RSA, ECC, or hybrid as per the type of encryption performed at the sender's side block (1206B-1).

Furthermore, the output of the decryption process may regenerate the plain text data which was originally present at the sender's side at block (1202A) and may now be available in the recipient's device block (1202-B).

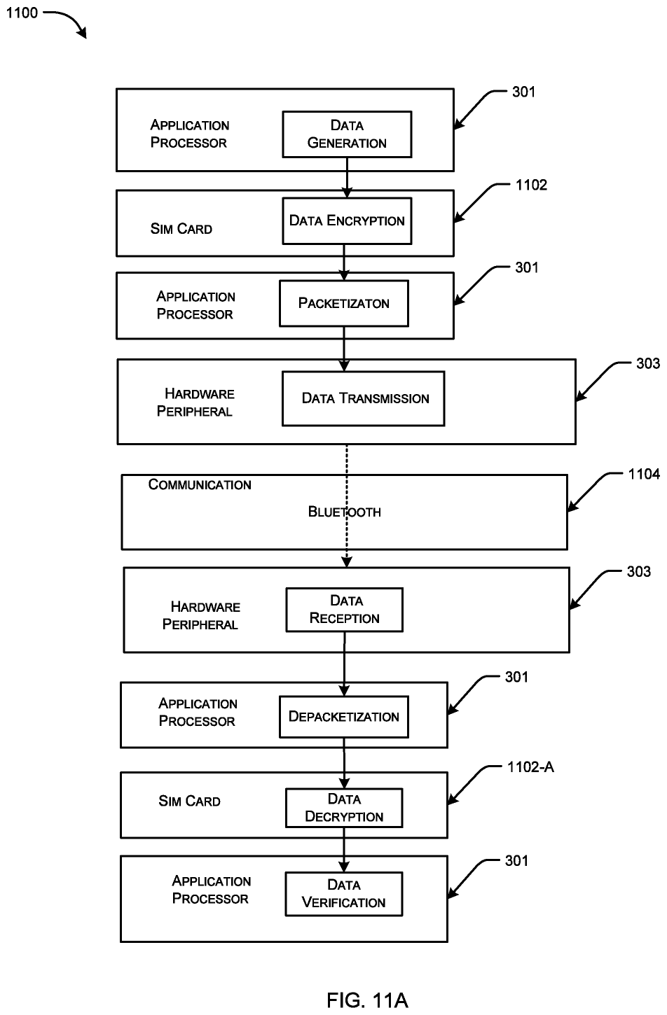

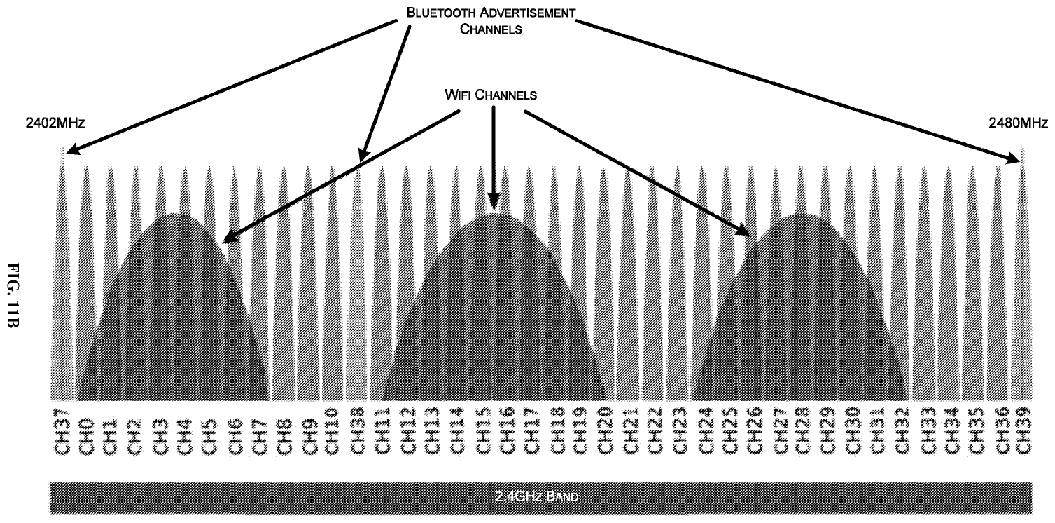

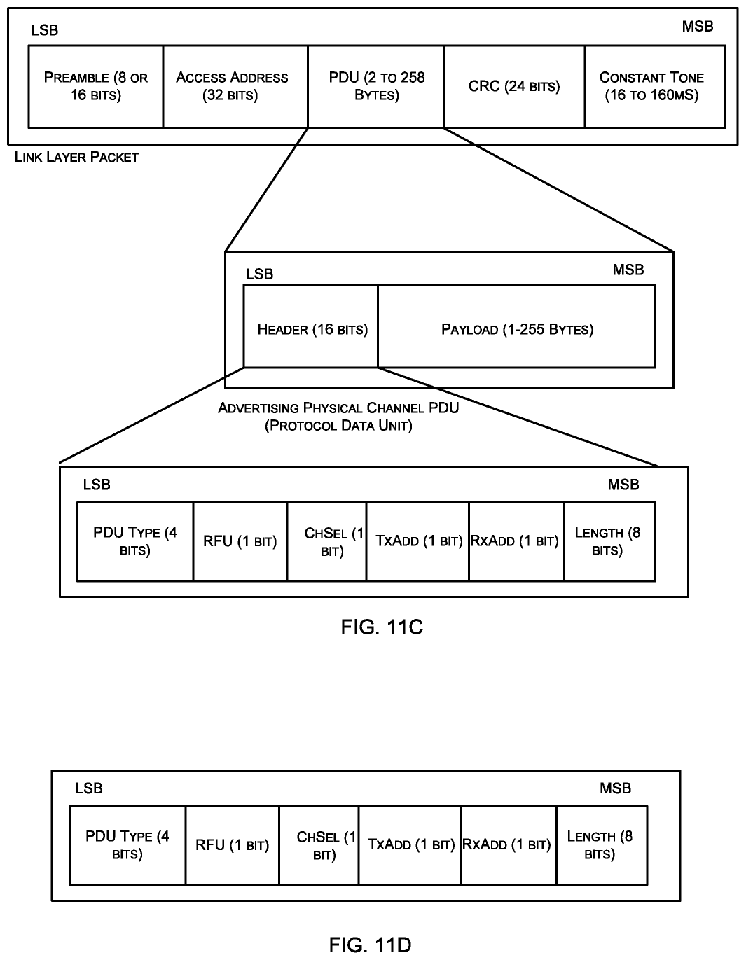

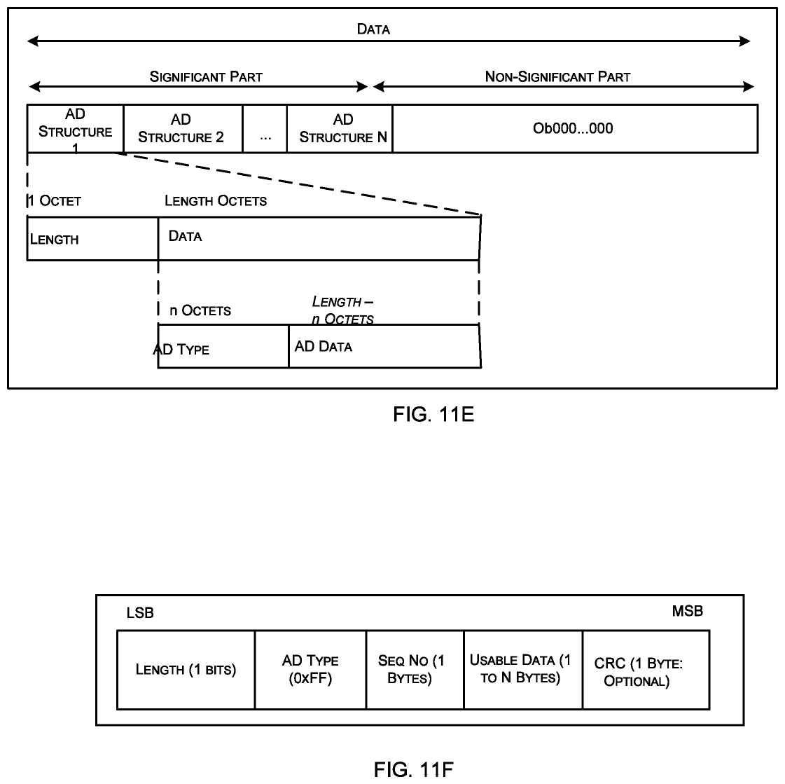

FIGS. 11A-11F illustrate exemplary representations (1100) of secure communication over Bluetooth, in accordance with an embodiment of the present disclosure.

As illustrated in FIG. 11A, blocks (1102) and (1102A) may be used for communication of data. The Bluetooth communication-specific block (1104) may provide a Bluetooth link for fast transactions. FIG. 11A may include the functionality of the remaining blocks as described earlier in FIG. 3. The functionality of the remaining blocks may not be explained from the point of view of brevity. However, as a fundamental principle, all communication (including Bluetooth) may be simplex in nature and may not include “pairing” i.e. there will not be any explicit connection based on mutual handshaking. In simplex communication, data may be sent or transmitted, or broadcasted from one device to another device or devices. The Bluetooth option provides faster communication with less user interaction. Further, received data (303) may be decrypted at block (1102A) as shown in in FIG. 11A.

In an exemplary embodiment, the Bluetooth communication type may include the advertising feature as the mode of data transmission from one device to another device. The data may include, but not be limited to, identity information, transaction information, and an acknowledgment signal. The definition and frame structure of data may be dependent on a specific application.

For security, the advertising frame or packet may be accessible to all the devices in the vicinity. For example, any device in the vicinity accessing the Bluetooth signal can also read all the data transmitted by the Bluetooth device phrased as “advertising.” Hence, this channel of communication is linked with previous stages of data preparation as shown in “data encryption” ((154) in FIG. 1B) and “packetization” ((156) in FIG. 1B) blocks. The “data encryption” block ensures data security and prevents other devices from accessing this data. It may also be noted, at the time of Bluetooth low energy (BLE) data transmission, all the data transmitted along with BLE source address may be a public address (media access control (MAC) address) or a configurable private address.

In an exemplary implementation, the size of data in transmission depends on the scope and specification of the peripheral hardware. The process of packetization may maintain the equilibrium between desired data to transmit at the application layer and the available memory to transmit at the physical or data-link layer. As indicated, the PHY (physical layer) specification of the Bluetooth may be BLE 4.X (LE 1M PHY), 5.X (LE 2M PHY), and others. It may be appreciated that various configurations may be enabled to achieve maximum output. In an embodiment, Bluetooth configuration may be based on the hardware capability of the device and may be configured to achieve maximum data size in the advertising packet and the frequency of data broadcast interval.

Bluetooth may be configured to work free of license in the industrial, scientific, and medical (ISM) bands of 2.4 gigahertz to 2.48 gigahertz. The spectrum may be divided into multiple channels. The same frequency bandwidth may also be used by many other wireless devices such as Wi-Fi and proprietary RF broadcasting system.

FIG. 11B illustrates a frequency spectrum of the Bluetooth and the Wi-Fi channels. As shown in FIG. 11B, the three channels (Channel-37, Channel-38, Channel-39) out of 40 channels of Bluetooth may be used for broadcasting “advertisement,” while other channels may be used to send data after pairing. In Bluetooth BLE-4.X, only three channels may be used to broadcast advertising data, whereas in BLE 5.X onwards, the other 37 channels (Channel-0 to Channel-36) may be configured for advertisement. The usage of advertising channels (as many as possible) depends on the lowest common hardware availability of the smartphone of the sender and the receiver.

The Bluetooth advertising data may be broadcasted with a configurable interval ranging from 20 milliseconds to 10.24 seconds along with a small random delay of 0 seconds to 0.625 milliseconds to avoid interference from multiple devices. Small intervals may be used to increase data available for broadcasting advertisements to the scanner or receiver. However, small advertising intervals increase the possibility of interferences in the case of multiple devices broadcasting in the same region. Hence, small intervals may be selected appropriately based on the application to achieve optimum results.

FIG. 11C describes a link-layer (LL) packet structure that may further include the following:

Preamble: All LL packets may contain a preamble, which is used in the receiver to perform frequency synchronization, automatic gain control (AGC) training, and symbol timing estimation. The preamble may be a fixed sequence alternating between 0 and 1 bits. For the BLE packets transmitted on the LE 1M PHY and LE 2M PHY, the preamble size may be between 1 octet and 2 octets, respectively.

Access Address: The access address may be a 4-octet value. Each periodic advertising train may have a distinct access address. Each time, the BLE device needs a new access address while the LL generates a new random value.

Protocol data unit (PDU): When a BLE packet is transmitted on either the primary (Ch37, Ch38, and Ch39) or secondary advertising physical channels (Ch0 to Ch36) or the periodic physical channel, the PDU may be defined as the advertising physical channel PDU. When a packet is transmitted on the data physical channel, the PDU may be defined as the data physical channel PDU.

Cyclic redundancy check (CRC): The size of the CRC may be 3 octets and may be calculated on the PDU of all LL packets. If the PDU is encrypted, then the CRC may be calculated after the encryption of the PDU is complete. The CRC polynomial has the form x²⁴+x¹⁰+x⁹+x⁶+x⁴+x³+x+1.

Constant Tone (CTE): The CTE may consist of a constantly modulated series of unwhitened 1s. This field has a variable length that ranges from 16 microseconds to 160 microseconds.

FIG. 11D illustrates a PDU header. The PDU frame may contain 2 to 258 octets or bytes. It may have a header (2 octets) and a payload (1 to 255 bytes). Further, the payload may include the advertising data size.

The PDU header of 2 octets or bytes may define the way the transmitter behaves while the packet or payload contains data. The header frame may consist of 4 bits with various configuration options. The configuration parameter shown in bold in Table 5 may be not allowed, while the other parameters may be accepted for use in the proposed Bluetooth-based transaction.

TABLE 5

| PDU | | |
|---|---|---|
| Type | PDU Name | Remark |
| 0b0000 | ADV_{—}IND | Connectable Scannable Undirected advertising. |
| 0b0001 | ADV_{—}DIRECT_{—}IND | Connectable Directed advertising |
| 0b0010 | ADV_NONCONN_IND | Non-Connectable Non-Scannable Undirected adv. |
| 0b0011 | SCAN_{—}REQ | Scan Request on Primary channels |
| | AUX_{—}SCAN_{—}REQ | Scan Request on Secondary channels |
| 0b0100 | SCAN_{—}RSP | Scan Response on Primary channels |
| 0b0101 | CONNECT_{—}IND | For Connection Req in Primary |
| | AUX_{—}CONNECT_{—}REQ | For Connection Req in Secondary |
| 0b0110 | ADV_{—}SCAN_{—}IND | Scannable Undirected advertising |
| 0b0111 | ADV_{—}EXT_{—}IND | Extended advertising Primary |
| | AUX_{—}ADV_{—}IND | Extended advertising Secondary |
| | AUX_{—}SCAN_{—}RSP | Scan Response on Secondary channels |
| | AUX_SYNC_IND | Periodic Advertising |
| | AUX_CHAIN_IND | Chaining of Sec. Advertising Packet |
| 0b1000 | AUX_{—}CONNECT_{—}RSP | connection response packet sent on Secondary |

The configuration of other parameters of PDU Header Packet are indicated in Table 6 below:

TABLE 6

| | | Max Data | | BLE 5.X and |
|---|---|---|---|---|
| PDU | | Length (Payload | Legacy (BLE 4.X) | above |
| Type | PDU Name | Data-1 Byte) | compatibility | compatibility |
| 0b0010 | ADV_NONCONN_IND | 31 | YES | YES |
| 0b0111 | AUX_SYNC_IND | 254 | No | Yes |
| | AUX_CHAIN_IND | 254 | | |

ChSel: 0 or 1. (1 if the advertiser supports the LE channel selection algorithm)

TxAdd: Preferred 0, else 1. (1 if the advertiser's address is random, and set to 0 if the address is public)

RxAdd: Preferred 0 else 1 (1 if the target device's address is random, and set to 0 if the address is public)

Length: Holds the length of the payload of the packet.

FIG. 11E illustrates a payload data structure. The payload data structure may contain 1 to 255 bytes of data. In case of lower than BLE 5.X, the maximum payload size may be 32 bytes (excluding SCAN_RESPONSE data of another 32 bytes) and for BLE 5.X it may be up to 255 bytes (excluding auxiliary channel advertisement). Further, the packet may be divided into a significant part and a non-significant part. The unused data in the frame may be called a non-significant part and transmitted as zero. The significant part may be further coded into multiple parts and called an advertisement data (AD) structure. Multiple ADs may fit one after another within the maximum length of the payload size. Each AD may contain one byte of length information and the other may include AD information which may be further split into an AD Type (1 byte), and an AD Data (variable). Hence, below the BLE 5.0 core specification, the maximum useable data may be less than 36 bytes and in BLE 5.X, it may be 254 bytes. One byte in each case may be used to denote the length of the significant data part of the payload data structure.

In an exemplary implementation, as per the available and usable data in the link layer of Bluetooth advertising “Payload frame” based in BLE 4.X or BLE 5.X, the data packetization is being done. Using auxiliary channels and an advertising chain, the BLE-5.X may send about 1.5 kilobytes of data in a single iteration of advertisement which is much higher than 36 bytes of data in BLE 4.X. The required data to be sent per application channel may be much higher than available data size in the link layer. During the situation, the “application data” may be divided into suitable chunks (that fit into the LL) and the advertisement data may be dynamically updated one after another.

In an exemplary embodiment, the BLE scanner may receive data to be broadcasted or advertised. There may be many devices broadcasting simultaneously on the same or different channels. Hence, scanning and filtration of data may involve a tedious and complex operation by the scanner. Based on the application and use-case area, the advertising interval may be further tuned.

The mechanism of updating an advertising packet may not be part of the BLE core specification and may be further dependent on the hardware chip manufacturer to provide a suitable interface to update the packet. In many hardware chips, the advertising data buffer may not be updated during transmission. In that situation, the transmission or broadcasting loop may be stopped to update the advertising data buffer which may ultimately add a time lag to the scanner. Hence, proper data or packet linkage information in subsequent advertising packets may be necessary to maintain the data integrity while reconstructing the complete advertisement data at the scanner end. Further, the data linkage mechanism may occupy a space within the payload data structure.

FIG. 11F represents an exemplary embodiment of the data linkage and the frame structure when the application data size is large with multiple advertisement packets. The “sequence number” and the “CRC” field as indicated in FIG. 11F, may be added to the payload data structure of the Bluetooth advertising payload frame. The sequence number may help in reconstructing the complete packet at the scanner. The CRC shall ensure data integrity which is optional and may be removed to increase useable data size buffer length. A sequence number of 1 byte may allow the transmission of 255 packets and a total length of 255×N bytes of advertising data.

As an example of BLE4.2, the maximum value of N shall be 25 Bytes (in available hardware) without CRC. Further, using multiple advertising packets, the BLE4.2 may send 1 kilobyte of application layer data in about 700 milliseconds without packet loss. In case packet loss, another 700 milliseconds may be required to reconstruct the entire data. This method may be enhanced by enabling “SCAN_RESP” feature of the PDU type header configuration. The BLE Scanner on the other side may receive the advertised packet along with the source device address. The application layer data (at payload) may be constituted with a source device address to ensure the respective payload data and the device hardware originating from the same source.

In an exemplary embodiment, the application level data (used as payload data) may use the entire source device address or parts or derivation such as HASH or a few bytes of Hash, a digitally signed “device address” or encrypted “device address.”

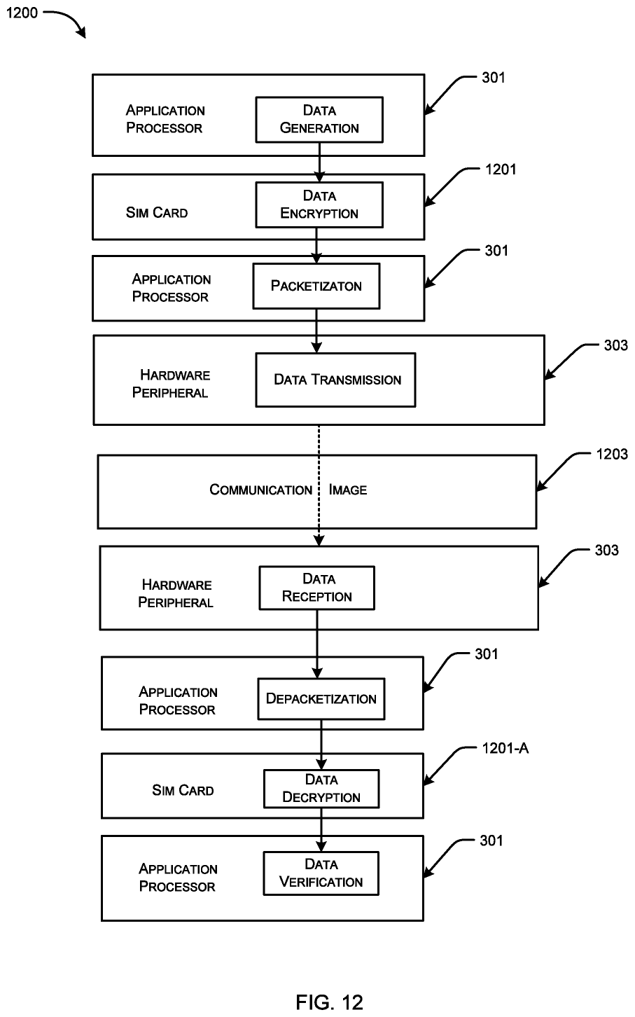

FIG. 12 illustrates an exemplary representation of secure communication over a quick response code (1200), in accordance with an embodiment of the present disclosure.

The image-based data communication block (1203) may include QR codes to transmit data in one way from the sender to the recipient or vice versa. In an exemplary embodiment, the system (110) may enable only a byte by byte mode encoding technique in offline payments compliant with the QR image as shown in Table 7.

TABLE 7

| Mode | Supported |
|---|---|
| Numeric | No |
| Alphanumeric | No |
| Byte | Yes |
| Kanji | No |

In an exemplary embodiment, large amounts of transactional data may be divided into parts that reproduce multiple OR images to be sent to the recipient. Based on a use case, a fast scan time and a data size may be selected with an appropriate QR type (error correction code and version number). Further, display intensity and display size of the sender (user equipment) may be the selected parameters for configuring the communication range of the QR based mode of communication.

Higher the version number, the higher the content supported by the QR image. However, with the higher version number, the QR generation as well as reading and scanning process time also increases. Further, the suggested QR version number for the QR image should be below level 20. Further, four error correction code types with different error correction capabilities may provide data recovery from the damaged or distorted QR image. Higher the error correction capability, the higher the overhead with smaller data.

Additionally, all the remaining blocks in FIG. 12 may include functionalities as described in FIG. 3. However, the remaining blocks may not be described in detail from the point of view of brevity.

In an exemplary embodiment, the error correction type “M” or above may be recommended based on the data size. Based on the total data size, application providers may use higher error correction types of “Q” or “H”.

In an exemplary implementation, Table 8 represents error correction levels in the percentage of damage and an overhead comparison with an embedded communications channel-L type endpoint communications channel (ECC-L type).

TABLE 8

| | Error correction | |
|---|---|---|
| | level in the | Overhead in |
| | percentage of | comparison of |
| ECC Type | damage | ECC-L type |
| L | 7% | 0% |
| M | 15% | 15%-30% |
| Q | 25% | 45%-80% |
| H | 30% | 100%-135% |

In an exemplary embodiment, the system may not mandate any specific user-level data structure and may be constructed for specific use cases. However, unlike other types of wireless communication mediums (Bluetooth, Wi-Fi, etc.) QR code is image-based information, hence may be more vulnerable to “replay attack.” To avoid a replay attack, a dynamic QR code may be adapted, where the QR code data shall be updated or refreshed within a predefined time (as per the requirement of the application) from, for example, 1 second to 1 minute or more. The higher the update rate, the higher processing power for rendering and scanning may be generated.

During the adaptation of the dynamic QR code, some part of the data or the entire data may be updated or changed over time and may be further rendered as a completely new QR image. The dynamic content of data may be derived from a random number or a sequential predictive series like date, time, etc. The exposure of dynamic data may depend on the encryption type. For asymmetric key-based encryption, the dynamic content of the data may be exposed as the entire data is signed and cannot be regenerated externally.

In an exemplary implementation, QR versioning may describe various versioning options in the QR code and elaborate supported types for offline payments. As shown in Table 9, the blocks highlighted in bold may be supported, whereas the blocks that are not highlighted may be unsupported.

TABLE 9

Input Data Size(Bytes)

| | ECC- | ECC- | ECC- | ECC- |
|---|---|---|---|---|
| | L | M | Q | H |
| 1 | 19 | 16 | 13 | 9 |
| 2 | 34 | 28 | 22 | 16 |
| 3 | 55 | 44 | 34 | 26 |
| 4 | 80 | 64 | 48 | 36 |
| 5 | 108 | 86 | 62 | 46 |
| 6 | 136 | 108 | 76 | 60 |
| 7 | 156 | 124 | 88 | 66 |
| 8 | 194 | 154 | 110 | 86 |
| 9 | 232 | 182 | 132 | 100 |
| 10 | 274 | 216 | 154 | 122 |
| 11 | 324 | 254 | 180 | 140 |
| 12 | 370 | 290 | 206 | 158 |
| 13 | 428 | 334 | 244 | 180 |
| 14 | 461 | 365 | 261 | 197 |
| 15 | 523 | 415 | 295 | 223 |
| 16 | 589 | 453 | 325 | 253 |
| 17 | 647 | 507 | 367 | 283 |
| 18 | 721 | 563 | 397 | 313 |
| 19 | 795 | 627 | 445 | 341 |
| 20 | 861 | 669 | 485 | 385 |
| 21 | 932 | 714 | 512 | 406 |
| 22 | 1006 | 782 | 568 | 442 |
| 23 | 1094 | 860 | 614 | 464 |
| 24 | 1174 | 914 | 664 | 514 |
| 25 | 1276 | 1000 | 718 | 538 |
| 26 | 1370 | 1062 | 754 | 596 |
| 27 | 1468 | 1128 | 808 | 628 |
| 28 | 1531 | 1193 | 871 | 661 |
| 29 | 1631 | 1267 | 911 | 701 |
| 30 | 1735 | 1373 | 985 | 745 |
| 31 | 1843 | 1455 | 1033 | 793 |
| 32 | 1955 | 1541 | 1115 | 845 |
| 33 | 2071 | 1631 | 1171 | 901 |
| 34 | 2191 | 1725 | 1231 | 961 |
| 35 | 2306 | 1812 | 1286 | 986 |
| 36 | 2434 | 1914 | 1354 | 1054 |
| 37 | 2566 | 1992 | 1426 | 1096 |
| 38 | 2702 | 2102 | 1502 | 1142 |
| 39 | 2812 | 2216 | 1582 | 1222 |
| 40 | 2956 | 2334 | 1666 | 1276 |

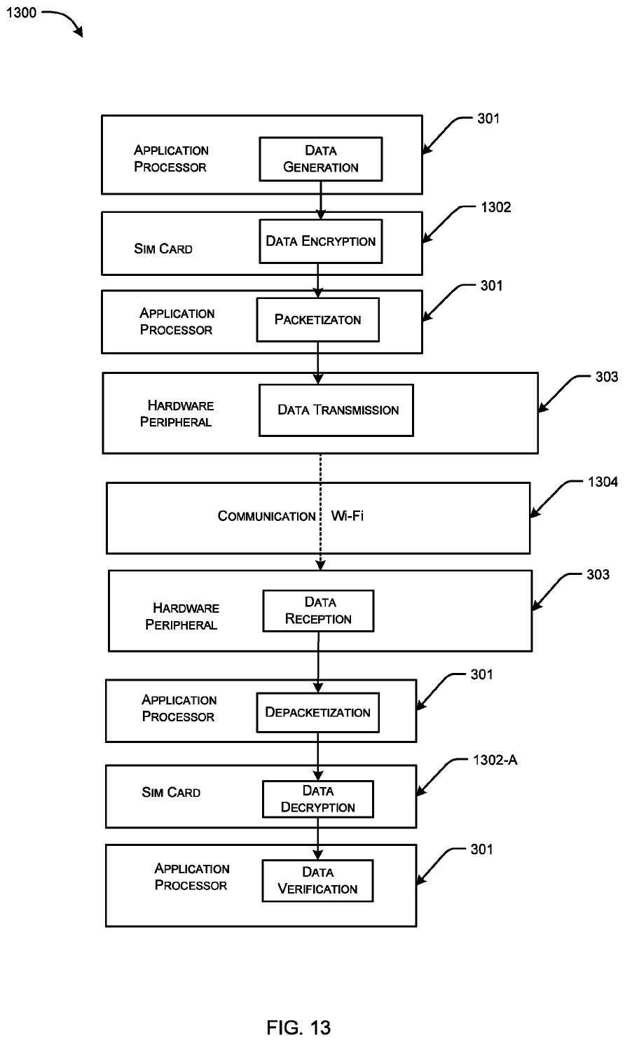

FIG. 13 illustrates an exemplary representation (1300) of secure communication over wireless fidelity (Wi-Fi), in accordance with an embodiment of the present disclosure.

In an exemplary embodiment, the predicted Wi-Fi based mode of communication between the sender (for example, SIM card (1302)) and the receiver (for example, SIM card (1302-A)) may not depend on the pairing or the approval from either side. Hence, it may save time and reduce user interaction with the system. For Wi-Fi-based secure data transmission, the feature of SSID of any Wi-Fi device or hotspot may be used to transmit data. Further, pairing between a sender and a receiver may not be required. A WiFi “SSID name” filed may be used to share data.

In an exemplary embodiment, the predicted Wi-Fi based mode of communication may include multiple parallel/simultaneous transmission, single reception/transmission. Further, the communication range may be controlled by the Wi-Fi module's transmitting power.

In an embodiment, the SSID data size may be allowed up to 32 bytes without any restriction on data types. Further, large amounts of transactional data may be divided into parts and shared by updating or changing the SSID name of a Wi-Fi hotspot or transmitter, periodically till the transaction persists. For sending a larger size of data (more than 32 bytes) and transmitting the data in multiple packets sequentially, the SSID name may be updated (with the next part of the data) within a predefined interval. The predefined interval may be linked with the receiver (or recipient device) scanning time capability. Suitable divisions may be ensured based on the amount of data to be transmitted. Additionally, all the remaining blocks in FIG. 13 may include functionalities as described in FIG. 1B. However, they may not be described in detail from the point of view of brevity.

For sequential multipacket transmission, the Wi-Fi data structure may follow the following data structure as indicated in Table 10.

TABLE 10

| | | | | |
|---|---|---|---|---|
| Sequence | Device ID | User Data Length | User Data | CRC |
| No. | (MAC - 6 | (Optional)(0-1 | (21-25 Bytes) | (Optional) |
| (1-2 Byte) | Bytes) | Byte) | | (0-2 Bytes) |

The one to two bytes of sequence number indicates the packet number in sequence, and 6 bytes of device identity (ID) is used to identify a particular device for which, in an embodiment, the media access control (MAC) address of the device can be used. The CRC may ensure data integrity at the application level while the remaining 21-25 bytes may be used as user data.

In an exemplary embodiment, for transmitting or broadcasting a stream of data containing a string of 36 characters, for example, “abcdefghijklmnopqrstuvwxyz0123456789”, without any CRC following packets, an SSID name of the Wi-Fi as indicated in Table 10 may be required. As shown in Table 11, data may be broadcasted over two SSID updates with 30 bytes and 6 bytes of user data respectively. The SSID may be updated until the transaction is aborted or completed based on a reverse acknowledgment signal from the recipient to the sender during transmission.

TABLE 11

| | | | User Data | | |
|---|---|---|---|---|---|
| | Sequence | Device ID | Length | | CRC |
| | No. (1-2 | (MAC - 6 | (Optional) | User Data | (Optional) |
| | Byte) | Bytes) | (0-1 Byte) | (21-25 Bytes) | (0-2 Bytes) |
| SSID- | 0x01 | 0Xaabbccddeeff | 0x18 | Abcdefghijklmnopqrstuvwx | NA |
| 1 | | | | | |
| SSID- | 0x02 | 0xAABBCCDDEEFF | 0x0C | Yz0123456789 | NA |
| 2 | | | | | |

The possibility of a replay attack (as SSID information is easily scannable) may be avoided by considering device hardware information (MAC ID) as a part of the data. Further, the encrypted user data may contain originating or source hardware information and may be invalidated if replayed by other spurious hardware trying to clone or mimic the data.

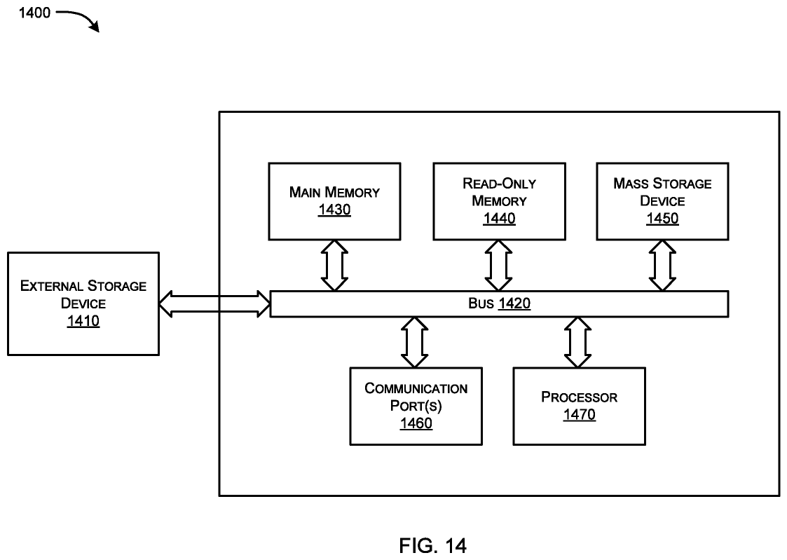

FIG. 14 illustrates an exemplary computer system (1400) in which or with which the proposed system (110) may be implemented, in accordance with an embodiment of the present disclosure.

In an embodiment, the primary entity (104), the secondary entity (108), and/or the system (110) may be implemented as the computer system (1400).

As shown in FIG. 14, the computer system (1400) may include an external storage device (1410), a bus (1420), a main memory (1430), a read-only memory (1440), a mass storage device (1450), a communication port(s) (1460), and a processor (1470). A person skilled in the art will appreciate that the computer system (1400) may include more than one processor and communication ports. The communication port(s) (1460) may be chosen depending on a network, such as a Local Area Network (LAN), Wide Area Network (WAN), or any network to which the computer system (1400) connects. The main memory (1430) may be Random Access Memory (RAM), or any other dynamic storage device commonly known in the art. The read-only memory (1440) may be any static storage device(s) e.g., but not limited to, a Programmable Read Only Memory (PROM) chip for storing static information e.g., start-up or basic input/output system (BIOS) instructions for the processor (1470). The mass storage device (1450) may be any current or future mass storage solution, which can be used to store information and/or instructions.

The bus (1420) may communicatively couple the processor(s) (1470) with the other memory, storage, and communication blocks. Optionally, operator and administrative interfaces, e.g., a display, keyboard, and cursor control device may also be coupled to the bus (1420) to support direct operator interaction with the computer system (1400). Other operator and administrative interfaces can be provided through network connections connected through the communication port(s) (1460). In no way should the aforementioned exemplary computer system (1400) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method that facilitates secure storage within a subscriber identity module (SIM) card.

The present disclosure provides a system and a method that facilitates secure computation within the SIM card.

The present disclosure provides a system and a method that provides various modes of communication associated with user requirements.

The present disclosure provides a system and a method that enhances the range of communication with the enablement of various input and output peripherals.

We claim:

1. A system (110) for enabling communication of data between a primary entity (104) and a secondary entity (108), the system (110) comprising:
one or more processors (202) operatively coupled with the primary entity (104) and a memory (204), wherein said memory (204) stores instructions which when executed by the one or more processors (202) causes the one or more processors (202) to:
generate one or more data parameters based on one or more target applications requested by a user (102) associated with the primary entity (104), wherein the primary entity (104) is operably coupled to a subscriber identity module (SIM) card;
encrypt, using one or more primary techniques, the generated one or more data parameters based on the requested one or more target applications;
predict, using an artificial intelligence (AI) engine (210), an audio mode of communication (106) based on the generated one or more encrypted data; and
enable the communication of the one or more encrypted data from the primary entity (104) to the secondary entity (108) via the audio mode of communication (106).

2. The system (110) as claimed in claim 1, wherein the one or more processors (202) are configured to packetize the generated one or more data parameters based on the one or more target applications prior to generating the one or more encrypted data.

3. The system (110) as claimed in claim 1, wherein the one or more target applications comprise at least one or more payment information and sensitive information associated with the one or more target applications.

4. The system (110) as claimed in claim 1, wherein the one or more processors (202) are configured to encrypt the generated one or more data parameters using a certified authority/public key infrastructure (CA/PKI) feature.

5. The system (110) as claimed in claim 1, wherein the one or more processors (202) are configured to encrypt the one or more generated data parameters using one or more asymmetric keys and the one or more primary techniques.

6. The system (110) as claimed in claim 1, wherein the one or more processors (202) are configured to encrypt the one or more generated data parameters using one or more symmetric keys and the one or more primary techniques.

7. The system (110) as claimed in claim 5, wherein the one or more primary techniques comprise any or a combination of a Rivest-Shamir-Adleman (RSA) technique and an elliptical curve cryptography (ECC) technique to encrypt the one or more generated data parameters with the one or more asymmetric keys.

8. The system (110) as claimed in claim 6, wherein the one or more primary techniques comprise any or a combination of an advanced encryption standard (AES) technique, a data encryption standard (DES) technique, and a triple data encryption standard (3 DES) technique to encrypt the one or more generated data parameters with the one or more symmetric keys.

9. The system (110) as claimed in claim 1, wherein the one or more processors (202) are configured to use any or a combination of a secure hash algorithm (SHA) technique and a message-digest algorithm 5 (MD5) technique to encrypt the one or more generated data parameters.

10. The system (110) as claimed in claim 1, wherein the audio mode of communication configured by the one or more processors (202) utilizes frequency shift keying (FSK) to enable the communication of the one or more encrypted data from the primary entity (104) to the secondary entity (108).

11. The system (110) as claimed in claim 1, wherein the audio mode of communication comprises an audio amplitude variation to enable the communication of the one or more encrypted data from the primary entity (104) to the secondary entity (108).

12. The system (110) as claimed in claim 1, wherein the audio mode of communication utilizes one or more frequencies to enable the communication of the one or more encrypted data from the primary entity (104) to the secondary entity (108).

13. A method for enabling a short distance communication between one or more entities, the method comprising:
generating, by one or more processors (202), one or more data parameters based on one or more target applications requested by a user (102) associated with a primary entity (104), wherein the primary entity (104) is operably coupled to a subscriber identity module (SIM) card;
encrypting, by the one or more processors (202), the generated one or more data parameters based on the requested one or more target applications using one or more primary techniques;
predicting, by the one or more processors (202), an audio mode of communication (106) based on the one or more encrypted data through an artificial intelligence (AI) engine (210); and
enabling, by the one or more processors (202), the communication of the one or more encrypted data from the primary entity (104) to a secondary entity(108) via the audio mode of communication (106).

14. The method as claimed in claim 13, comprising encrypting, by the one or more processors (202), the one or more generated data parameters using a certified authority/public key infrastructure (CA/PKI) feature.

15. The method as claimed in claim 13, comprising encrypting, by the one or more processors (202), the one or more generated data parameters using one or more asymmetric keys and the one or more primary techniques.

16. The method as claimed in claim 13, comprising encrypting, by the one or more processors (202), the one or more generated data parameters using one or more symmetric keys and the one or more primary techniques.

17. The method as claimed in claim 15, wherein the one or more primary techniques comprise any or a combination of a Rivest-Shamir-Adleman (RSA) technique and an elliptical curve cryptography (ECC) technique to encrypt the one or more generated data parameters with the one or more asymmetric keys.

18. The method as claimed in claim 16, wherein the one or more primary techniques comprise any or a combination of an advanced encryption standard (AES) technique, a data encryption standard (DES) technique, and a triple data encryption standard (3 DES) technique to encrypt the one or more generated data parameters with the one or more symmetric keys.

19. The method as claimed in claim 13, wherein the audio mode of communication utilizes frequency shift keying (FSK) to enable the communication of the one or more encrypted data from the primary entity (104) to the secondary entity (108).

20. The method as claimed in claim 13, wherein the audio mode of communication comprises audio amplitude variation to enable the communication of the one or more encrypted data from the primary entity (104) to the secondary entity (108).

21. The method as claimed in claim 13, wherein the audio mode of communication utilizes one or more frequencies to enable the communication of the one or more encrypted data from the one or more primary entity (104) to the one or more secondary entity (108).

22. A user equipment (UE) (104) for generating one or more secure messages, said UE (104) comprising:
one or more primary processors communicatively coupled to one or more processors (202) in a system (110), the one or more primary processors coupled with a memory, wherein said memory stores instructions which when executed by the one or more primary processors causes the UE (104) to:
generate and transmit one or more data parameters based on one or more target applications requested by a user (102) associated with the UE (104),
wherein the one or more processors (202) are configured to:
encrypt the received one or more data parameters received from the UE (104) using one or more primary techniques based on the one or more target applications;
predict, using an artificial intelligence (AI) engine (210), an audio mode of communication (106) based on the generated one or more encrypted data; and
enable the communication of the one or more encrypted data from the UE (104) to a secondary entity (108) via the audio mode of communication (106).

23. The UE (104) as claimed in claim 22, wherein the UE (104) is operably coupled to a subscriber identity module (SIM) card for the generation and the transmission of the one or more data parameters.

24. A subscriber identity module (SIM) card for enabling communication of data to a secondary entity (108), the SIM card comprising:
one or more processors communicatively coupled to one or more processors (202) in a system (110), the one or more processors coupled with a memory, wherein said memory stores instructions which when executed by the one or more processors causes the SIM card to:
generate one or more data parameters based on one or more target applications requested by a user (102);
encrypt, using one or more primary techniques, the generated one or more data parameters based on the requested one or more target applications;
predict, using an artificial intelligence (AI) engine (210), an audio mode of communication (106) based on the generated one or more encrypted data; and
enable the communication of the one or more encrypted data from the SIM card associated with a primary entity (104) to the secondary entity (108) via the audio mode of communication (106).

25. A system (110) for communication of data between a primary entity (104) and a secondary entity (108), the system (110) comprising:
one or more processors (202) operatively coupled with the primary entity (104) and a memory (204), wherein said memory (204) stores instructions which when executed by the one or more processors (202) cause the one or more processors (202) to:
generate one or more data parameters based on one or more target applications requested by one or more users (102), wherein the one or more users (102) are associated with the primary entity (104), wherein the primary entity (104) is operably coupled to a subscriber identity module (SIM) card;
encrypt, using one or more primary techniques, the generated one or more data parameters based on the requested one or more target applications;
determine a mode of communication (106) via an artificial intelligence (AI) engine (210) based on the generated one or more encrypted data, wherein the determined mode of communication (106) comprises at least a Bluetooth mode of communication; and
enable the communication of the one or more encrypted data from the primary entity (104) to the secondary entity (108) via the determined mode of communication (106).

26. The system (110) as claimed in claim 25, wherein one or more advertising channels are associated with the Bluetooth mode of communication to enable the communication of the one or more encrypted data from the primary entity (104) to the secondary entity (108).

27. The system (110) as claimed in claim 26, wherein the one or more processors (202) are configured to transmit a public address and a private address associated with the one or more advertising channels of the Bluetooth mode of communication.

28. The system (110) as claimed in claim 25, wherein the Bluetooth mode of communication (106) uses a data link layer with a physical specification of 4.X (LE 1M PHY) and 5.X (LE 2M PHY).

29. The system (110) as claimed in claim 28, wherein the data link layer comprises at least a preamble, an access address, a protocol data unit (PDU), a cyclic redundancy check (CRC), and a constant tone (CTE).

30. The system (110) as claimed in claim 25, wherein the one or more encrypted data is transmitted using a configurable interval ranging from 20 milliseconds to 10.24 seconds with a delay of 0 seconds to 0.625 milliseconds.

31. The system (110) as claimed in claim 26, wherein the primary entity (104) and the secondary entity (108) comprise one or more Bluetooth low energy (BLE) scanners to transmit and receive the one or more encrypted data through the one or more advertising channels.

32. A method for communication of data between a primary entity (104) and a secondary entity (108), the method comprising:
generating, by one or more processors (202), one or more data parameters based on one or more target applications requested by one or more users (102), wherein the one or more users (102) are associated with the primary entity (104), wherein the primary entity (104) is operably coupled to a subscriber identity module (SIM) card;
encrypting, by the one or more processors (202) using one or more primary techniques, the generated one or more data parameters based on the one or more target applications;
determining, by the one or more processors (202), a mode of communication (106) via an artificial intelligence (AI) engine (210) based on the one or more encrypted data, wherein the determined mode of communication (106) comprises at least a Bluetooth mode of communication; and
enabling, by the one or more processors (202), the communication of the one or more encrypted data from the primary entity (104) to the secondary entity (108) via the determined mode of communication (106).

33. A user equipment (UE) (104) for communication of data to a secondary entity (108), said UE (104) comprising:
a subscriber identity module (SIM) card;
one or more primary processors communicatively coupled to one or more processors (202) in a system (110), the one or more primary processors coupled with a memory, wherein said memory stores instructions which when executed by the one or more primary processors causes the UE (104) to:
generate and transmit one or more data parameters based on one or more target applications requested by one or more users (102), wherein the one or more users (102) are associated with the UE (104),
wherein the one or more processors (202) are configured to:
receive the one or more data parameters from the UE (104);
encrypt, using one or more primary techniques, the generated one or more data parameters based on the requested one or more target applications;
determine a mode of communication (106) via an artificial intelligence (AI) engine (210) based on the generated one or more encrypted data, wherein the determined mode of communication (106) comprises at least a Bluetooth mode of communication; and
enable the communication of the one or more encrypted data to a secondary entity (108) via the determined mode of communication (106).

34. A subscriber identity module (SIM) card for enabling communication of data to a secondary entity (108), the SIM card comprising:
one or more processors communicatively coupled to one or more processors (202) in a system (110), the one or more processors coupled with a memory, wherein said memory stores instructions which when executed by the one or more processors causes the SIM card to:
generate one or more data parameters based on one or more target applications requested by a user (102);
encrypt, using one or more primary techniques, the generated one or more data parameters based on the requested one or more target applications;
predict, using an artificial intelligence (AI) engine (210), a Bluetooth mode of communication (106) based on the generated one or more encrypted data; and
enable the communication of the one or more encrypted data from the SIM card associated with a primary entity (104) to the secondary entity (108) via the Bluetooth mode of communication (106).

35. A system (110) for enabling communication of data between a primary entity (104) and a secondary entity (108), the system (110) comprising:
one or more processors (202) operatively coupled with the primary entity (104) and a memory (204), wherein said memory (204) stores instructions which when executed by the one or more processors (202) cause the one or more processors (202) to:
generate one or more data parameters based on one or more target applications requested by one or more users (102) associated with the primary entity (104), wherein the primary entity (104) is operably coupled to a subscriber identity module (SIM) card;
encrypt, using one or more primary techniques, the generated one or more data parameters based on the requested one or more target applications;
determine a mode of communication (106) via an artificial intelligence (AI) engine (210) based on the generated one or more encrypted data, wherein the determined mode of communication (106) comprises at least a quick response code (QR) based mode of communication; and
enable the communication of the one or more encrypted data from the primary entity (104) to the secondary entity (108) via the determined mode of communication (106).

36. The system (110) as claimed in claim 35, wherein the QR based mode of communication uses a binary mode of encoding to enable the communication of the one or more encrypted data from the primary entity (104) to the secondary entity (108).

37. The system (110) as claimed in claim 35, wherein the QR based mode of communication comprises at least one of an error correction code (ECC), an error correction level, and an overhead associated with the encrypted one or more data.

38. The system (110) as claimed in claim 35, wherein the QR based mode of communication uses a dynamic QR code associated with the encrypted one or more data to prevent one or more replay attacks during the communication of the one or more encrypted data from the primary entity (104) to the secondary entity (108).

39. The system (110) as claimed in claim 38, wherein the dynamic QR code is updated within a predefined time interval to prevent the one or more replay attacks during the communication of the one or more encrypted data from the primary entity (104) to the secondary entity (108).

40. A method for enabling communication of data between a primary entity (104) and a secondary entity (108), the method comprising:
generating, by one or more processors (202), one or more data parameters based on one or more target applications requested by one or more users (102) associated with the primary entity (104);
encrypting, by the one or more processors (202), the generated one or more data parameters using one or more primary techniques based on the one or more target applications, wherein the primary entity (104) is operably coupled to a subscriber identity module (SIM) card;
determining, by the one or more processors (202), via an artificial intelligence (AI) engine (210), a mode of communication (106) based on the one or more encrypted data, wherein the determined mode of communication (106) comprises at least a quick response code (QR) based mode of communication; and
enabling, by the one or more processors (202), the communication of the one or more encrypted data from the primary entity (104) to the secondary entity (108) via the determined mode of communication (106).

41. The method as claimed in claim 40, wherein the QR based mode of communication uses a binary mode of encoding to enable the communication of the one or more encrypted data from the primary entity (104) to the secondary entity (108).

42. The method as claimed in claim 40, wherein the QR based mode of communication comprises at least one of an error correction code (ECC), an error correction level, and an overhead associated with the encrypted one or more data.

43. The method as claimed in claim 40, wherein the QR based mode of communication uses a dynamic QR code associated with the encrypted one or more data to prevent one or more replay attacks during the communication of the one or more encrypted data from the primary entity (104) to the secondary entity (108).

44. The method as claimed in claim 43, comprising updating, by the one or more processors (202), the dynamic QR code within a predefined time interval to prevent the one or more replay attacks during the communication of the one or more encrypted data from the primary entity (104) to the secondary entity (108).

45. A user equipment (UE) (104) for generating one or more secure messages, said UE (104) comprising:
a subscriber identity module (SIM) card;
one or more primary processors communicatively coupled to one or more processors (202) in a system (110), the one or more primary processors coupled with a memory, wherein said memory stores instructions which when executed by the one or more primary processors causes the UE (104) to:
generate and transmit one or more data parameters based on one or more target applications requested by one or more users associated with the UE (104),
wherein the one or more processors (202) are configured to:
receive the one or more generated data parameters from the UE (104);
encrypt, using one or more primary techniques, the generated one or more data parameters based on the requested one or more target applications;
determine a mode of communication (106) via an artificial intelligence (AI) engine (210) based on the generated one or more encrypted data, wherein the determined mode of communication (106) comprises at least a quick response code (QR) based mode of communication; and
enable communication of the one or more encrypted data from the UE (104) to a secondary entity (108) via the determined mode of communication (106).

46. A subscriber identity module (SIM) card for enabling communication of data to a secondary entity (108), the SIM card comprising:
one or more processors operatively coupled to one or more processors (202) in a system (110), wherein the one or more processors are coupled with a memory (204), wherein said memory (204) stores instructions which when executed by the one or more processors causes the one or more processors to:
generate one or more data parameters based on one or more target applications requested by one or more users (102);
encrypt, using one or more primary techniques, the generated one or more data parameters based on the requested one or more target applications;
determine a mode of communication (106) via an artificial intelligence (AI) engine (210) based on the generated one or more encrypted data, wherein the determined mode of communication (106) comprises at least a quick response code (QR) based mode of communication; and
enable the communication of the one or more encrypted data from the SIM card to the secondary entity (108) via the determined mode of communication (106).

47. A system (110) for enabling communication of data between a primary entity (104) and a secondary entity (108), the system (110) comprising:
one or more processors (202) operatively coupled with the primary entity (104) and a memory (204), wherein said memory (204) stores instructions which when executed by the one or more processors (202) cause the one or more processors (202) to:
generate one or more data parameters based on one or more target applications requested by one or more users (102) associated with the primary entity (104), wherein the primary entity (104) is operably coupled to a subscriber identity module (SIM) card;
encrypt, using one or more primary techniques, the generated one or more data parameters based on the requested one or more target applications;
determine a mode of communication (106) via an artificial intelligence (AI) engine (210) based on the generated one or more encrypted data, wherein the mode of communication (106) comprises at least a wireless fidelity (Wi-Fi) based mode of communication; and
enable the communication of the one or more encrypted data from the primary entity (104) to the secondary entity (108) via the determined mode of communication (106).

48. The system (110) as claimed in claim 47, wherein one or more service set identifiers (SSIDs) are associated with the Wi-Fi based mode of communication to enable the communication of the one or more encrypted data from the primary entity (104) to the secondary entity (108).

49. The system (110) as claimed in claim 48, wherein the one or more processors (202) are configured to update the one or more SSIDs within a predefined interval, and wherein the predefined interval is associated with the secondary entity (108).

50. The system (110) as claimed in claim 47, wherein the one or more encrypted data comprise at least a sequence number, a device identification (ID), a user data length, user data, and a cyclic redundancy check (CRC).

51. A method for enabling communication of data between a primary entity (104) and a secondary entity (108), the method comprising:
generating, by one or more processors (202), one or more data parameters based on one or more target applications requested by one or more users (102) associated with the primary entity (104), wherein the primary entity (108) is operably coupled to a subscriber identity module (SIM) card;
encrypting, by the one or more processors (202), the generated one or more data parameters, using one or more primary techniques based on the one or more target applications;
determining, by the one or more processors (202), a mode of communication (106) via an artificial intelligence (AI) engine (210) based on the one or more encrypted data, wherein the determined mode of communication (106) comprises at least a wireless fidelity (Wi-Fi) based mode of communication; and
enabling, by the one or more processors (202), the communication of the one or more encrypted data from the primary entity (104) to the secondary entity (108) via the determined mode of communication (106).

52. A user equipment (UE) (104) for communication of data to a secondary entity (108), said UE (104) comprising:
a subscriber identity module (SIM) card;
one or more primary processors communicatively coupled to one or more processors (202) in a system (110), the one or more primary processors coupled with a memory, wherein said memory stores instructions which when executed by the one or more primary processors causes the UE (104) to:
generate and transmit one or more data parameters based on one or more target applications requested by one or more users (102) associated with the UE (104),
wherein the one or more processors (202) are configured to:
receive the one or more generated data parameters from the UE (104);
encrypt, using one or more primary techniques, the generated one or more data parameters based on the one or more target applications;
determine a mode of communication (106) via an artificial intelligence (AI) engine (210) based on the generated one or more encrypted data, wherein the determined mode of communication (106) comprises at least a wireless fidelity (Wi-Fi) based mode of communication; and
enable the communication of the one or more encrypted data to the secondary entity (108) via the determined mode of communication (106).

53. A subscriber identity module card (SIM) card for enabling communication of data to a secondary entity (108), the SIM card comprising:
one or more processors operatively coupled to one or more processors (202) in a system (110) comprising a memory (204), wherein said memory (204) stores instructions which when executed by the one or more processors causes the SIM card to:
generate one or more data parameters based on one or more target applications requested by one or more users (102);
encrypt, using one or more primary techniques, the generated one or more data parameters based on the requested one or more target applications;
determine a mode of communication (106) via an artificial intelligence (AI) engine (210) based on the generated one or more encrypted data, wherein the mode of communication (106) comprises at least a wireless fidelity (Wi-Fi) based mode of communication; and
enable the communication of the one or more encrypted data from the SIM card associated with a primary entity (104) to the secondary entity (108) via the determined mode of communication (106).
